(19) United States
(12) Patent Application Publication
(10) Pub. No.: US 2026/0088664 A1
(43) Pub. Date: Mar. 26, 2026

(54) STATOR CORE FOR ROTATING ELECTRICAL MACHINE, STATOR, AND ROTATING ELECTRICAL MACHINE

(71) Applicant: MITSUBISHI ELECTRIC MOBILITY CORPORATION, Tokyo (JP)

(72) Inventors: Akihito MORI, Tokyo (JP); Kazuya HASEGAWA, Tokyo (JP); Kota HIROHASHI, Tokyo (JP)

(73) Assignee: MITSUBISHI ELECTRIC MOBILITY CORPORATION, Tokyo (JP)

(21) Appl. No.: 19/110,944

(22) PCT Filed: Nov. 2, 2022
(86) PCT No.: PCT/JP2022/041027

§ 371 Date: Mar. 12, 2025

(51) Int. Cl. H02K 1/14; H02K 1/16

(52) U.S. Cl. CPC H02K 1/148; H02K 1/16; H02K 2213/03

(57) ABSTRACT

Divisional cores include a plurality of kinds of fastening-portion-provided divisional cores of which the fastening portions are provided at a plurality of different positions separated from a center line connecting a rotation center axis of a rotating electrical machine and a circumferential-direction center of each divisional core. The fastening portions of different kinds of the fastening-portion-provided divisional cores are stacked on upper and lower sides in the stacking direction. The core plates are stacked such that contact parts of the divisional cores are located at positions different in the circumferential direction on the upper and lower sides in the stacking direction. The fastening holes of the fastening portions are formed in communication with each other in the stacking direction.

### TECHNICAL FIELD

The present disclosure relates to a stator core for a rotating electrical machine, a stator, and a rotating electrical machine.

### BACKGROUND ART

In a stator core for a rotating electrical machine, a stator, and a rotating electrical machine in conventional art, sector-shaped divisional cores divided in the circumferential direction are often used for the purposes of material yield improvement, winding assemblability improvement, and the like. In a case of fixing a stator core with a frame which forms a housing by bolts, the following structure is widely known: an outer circumferential part of the stator core has fastening portions in which fastening holes to be joined to the frame are formed, and divisional cores are lapped over each other (brick stacking) (see, for example, Patent Document 1).

### CITATION LIST

### Patent Document

Patent Document 1: Japanese U.S. Patent No. 5,609,619

### SUMMARY OF THE INVENTION

### Problem to be Solved by the Invention

In the stator core for the rotating electrical machine, the stator, and the rotating electrical machine in conventional art, a division number needs to be increased in order to improve the material yield of the divisional cores having the fastening portions. However, in a case where the division number is large or thick portions are provided for ensuring rigidity of the fastening portions, the fastening portions provided near both ends of the divisional cores need to be extremely small, and therefore the number and the shape of the fastening portions with the frame which forms the housing cannot be freely designed. Thus, it is impossible to achieve both of material yield improvement and freedom in designing of the fastening portions.

The present disclosure has been made to solve the above problem, and an object of the present disclosure is to provide a stator core for a rotating electrical machine, a stator, and a rotating electrical machine that make it possible to achieve both of material yield improvement and freedom in designing of the fastening portions.

### Means to Solve the Problem

A stator core for a rotating electrical machine according to the present disclosure is formed by stacking a plurality of core plates in an axial direction. Each core plate has a plurality of teeth and is divided in a circumferential direction, and is formed such that divisional cores of which a division number N (N being an integer) is four or more are arranged in contact with each other in the circumferential direction. Each core plate has, on an outer circumferential side thereof, fastening portions protruding outward in a radial direction and having fastening holes for fastening the core plates in a stacking direction. A number M (M being an integer) of the fastening portions in the circumferential direction is three or more, and a relationship of N≥M is satisfied. The divisional cores include a plurality of kinds of fastening-portion-provided divisional cores of which the fastening portions are provided at a plurality of different positions separated from a center line connecting a rotation center axis of the rotating electrical machine and a circumferential-direction center of each divisional core. The fastening portions of different kinds of the fastening-portion-provided divisional cores are stacked on upper and lower sides in the stacking direction. The core plates are stacked such that contact parts of the divisional cores are located at positions different in the circumferential direction on the upper and lower sides in the stacking direction. The fastening holes of the fastening portions are formed in communication with each other in the stacking direction.

A stator according to the present disclosure includes: the stator core for the rotating electrical machine described above; and a coil wound around the teeth of the stator core with an insulator therebetween.

A rotating electrical machine according to the present disclosure includes: the stator described above; and a rotor rotatably provided so as to be opposed to the stator with a gap therebetween.

### Effect of the Invention

The stator core for the rotating electrical machine, the stator, and the rotating electrical machine according to the present disclosure make it possible to achieve both of material yield improvement and freedom in designing of the fastening portions.

### BRIEF DESCRIPTION OF THE DRAWINGS

FIG. 1 is a perspective view showing the configuration of a stator for a rotating electrical machine according to embodiment 1.

FIG. 2 is a perspective view showing the configuration of a stator core for the rotating electrical machine shown in FIG. 1.

FIG. 3 is a plan view showing the configuration of the stator core shown in FIG. 2.

FIG. 4 is a plan view showing the configuration of a first divisional core of a core plate of the stator core shown in FIG. 2.

FIG. 5 is a plan view showing the configuration of a second divisional core of the core plate of the stator core shown in FIG. 2.

FIG. 6 is a plan view showing the configuration of a fastening-portion-less divisional core of the core plate of the stator core shown in FIG. 2.

FIG. 7 is a plan view showing the configuration of a first-stage core plate of the stator core shown in FIG. 2.

FIG. 8 is a plan view showing the configuration of a second-stage core plate of the stator core shown in FIG. 2.

FIG. 9 is a plan view showing the configuration of a part of the stator core shown in FIG. 2.

FIG. 10 is a perspective view showing the configuration of a part of the stator core shown in FIG. 2.

FIG. 11 is a plan view showing a manufacturing method for the first divisional core shown in FIG. 4.

FIG. 12 is a plan view showing a manufacturing method for the second divisional core shown in FIG. 5.

FIG. 13 is a plan view showing a manufacturing method for the fastening-portion-less divisional core shown in FIG. 6.

FIG. 14 is a plan view showing a method for manufacturing the first divisional core and the second divisional core shown in FIG. 4 and FIG. 5.

FIG. 15 is a plan view showing a manufacturing method for the first divisional core, the second divisional core, and the fastening-portion-less divisional core shown in FIG. 4, FIG. 5, and FIG. 6.

FIG. 16 is a perspective view showing the configuration of a stator core for a rotating electrical machine according to embodiment 2.

FIG. 17 is a plan view showing the configuration of the stator core shown in FIG. 16.

FIG. 18 is a plan view showing the configuration of a first-stage core plate of the stator core shown in FIG. 16.

FIG. 19 is a plan view showing the configuration of a second-stage core plate of the stator core shown in FIG. 16.

FIG. 20 is a graph showing the relationship between the material yield and the division number of divisional cores.

FIG. 21 is a perspective view showing the configuration of a stator core for a rotating electrical machine according to embodiment 3.

FIG. 22 is a plan view showing the configuration of the stator core shown in FIG. 21.

FIG. 23 is a plan view showing the configuration of a first divisional core of the stator core shown in FIG. 22.

FIG. 24 is a plan view showing the configuration of a second divisional core of the stator core shown in FIG. 22.

FIG. 25 is a plan view showing the configuration of a third divisional core of the stator core shown in FIG. 22.

FIG. 26 is a plan view showing the configuration of a fastening-portion-less divisional core of the stator core shown in FIG. 22.

FIG. 27 is a plan view showing the configuration of a first-stage core plate of the stator core shown in FIG. 21.

FIG. 28 is a plan view showing the configuration of a second-stage core plate of the stator core shown in FIG. 21.

FIG. 29 is a plan view showing a manufacturing method for the first divisional core shown in FIG. 23.

FIG. 30 is a plan view showing a manufacturing method for the second divisional core shown in FIG. 24.

FIG. 31 is a plan view showing a manufacturing method for the third divisional core shown in FIG. 25.

FIG. 32 is a plan view showing a manufacturing method for the fastening-portion-less divisional core shown in FIG. 26.

FIG. 33 is a plan view showing the configuration of a first-stage core plate of a stator core for a rotating electrical machine according to embodiment 4.

FIG. 34 is a plan view showing the configuration of a second-stage core plate of the stator core for the rotating electrical machine according to embodiment 4.

FIG. 35 is a perspective view showing the configuration of a stator core for a rotating electrical machine according to embodiment 5.

FIG. 36 is a plan view showing the configuration of the stator core shown in FIG. 35.

FIG. 37 is a plan view showing the configuration of a first divisional core of a core plate of the stator core shown in FIG. 35.

FIG. 38 is a plan view showing the configuration of a second divisional core of the core plate of the stator core shown in FIG. 35.

FIG. 39 is a plan view showing the configuration of a first-stage core plate of the stator core shown in FIG. 35.

FIG. 40 is a plan view showing the configuration of a second-stage core plate of the stator core shown in FIG. 35.

FIG. 41 is a plan view showing another configuration of the second-stage core plate of the stator core shown in FIG. 35.

FIG. 42 is a vertical sectional view showing the configuration of a rotating electrical machine according to each embodiment.

FIG. 43 is a plan view showing a comparative example in a manufacturing method for divisional cores of which the division number is three.

### DESCRIPTION OF EMBODIMENTS

A stator core for a rotating electrical machine according to each of embodiments is formed in a state in which divisional cores of a rotating electrical machine such as a motor are arranged in an annular shape. Accordingly, in the following description, directions about the rotating electrical machine are shown as a circumferential direction X, an axial direction Z, and a radial direction Y. In addition, for a stator core composing the rotating electrical machine, and other parts, the above directions apply in the same manner, and various directions are shown using the above directions as a reference, in the description.

### Embodiment 1

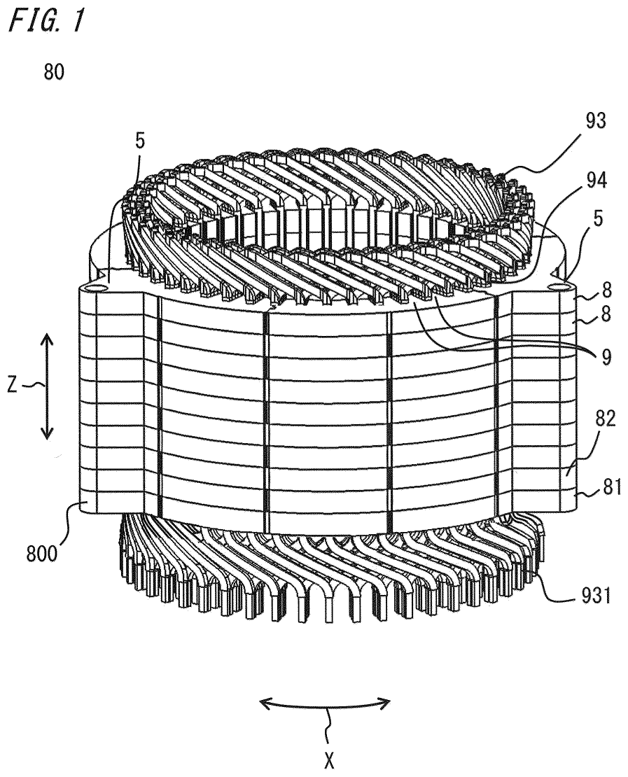

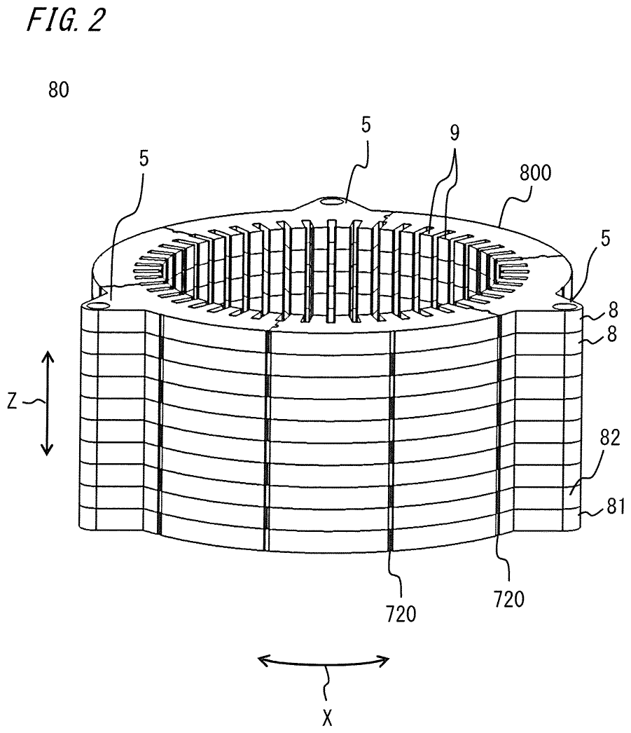

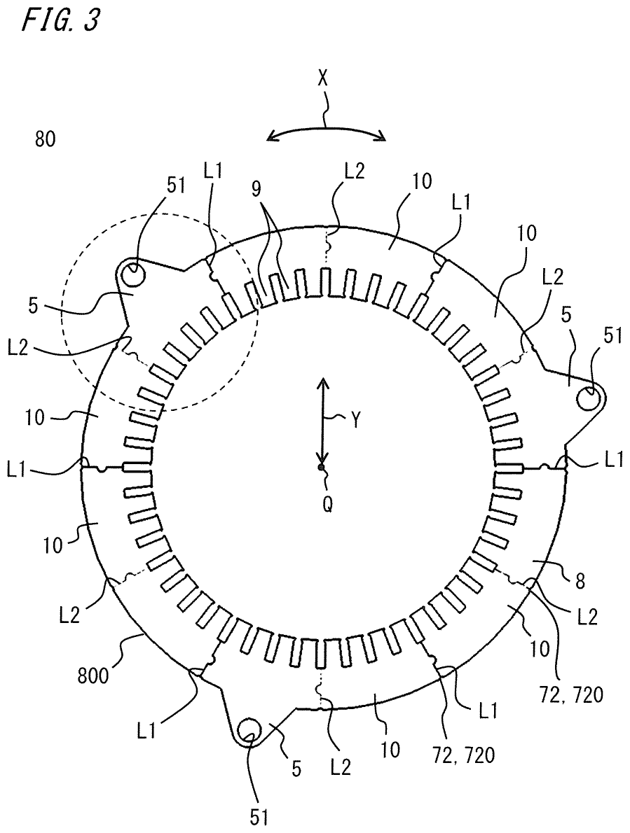

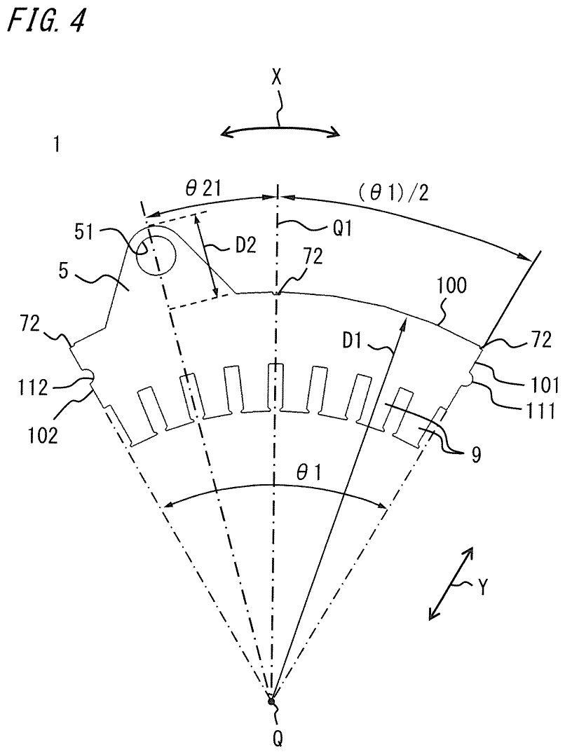

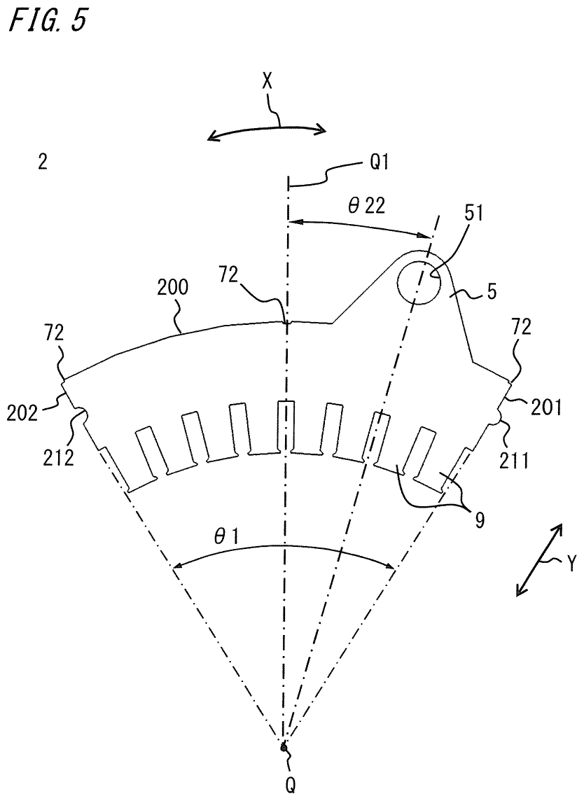

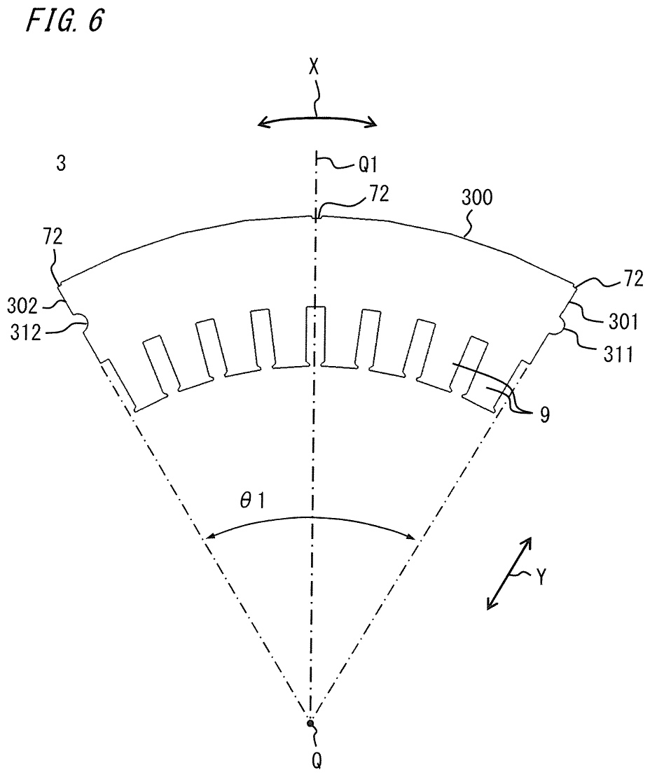

FIG. 1 is a perspective view showing the configuration of a stator for a rotating electrical machine according to embodiment 1. FIG. 2 is a perspective view showing the configuration of a stator core for the rotating electrical machine shown in FIG. 1. FIG. 3 is a plan view showing the configuration of the stator core shown in FIG. 2. FIG. 4 is a plan view showing the configuration of a first divisional core of a core plate of the stator core shown in FIG. 2. FIG. 5 is a plan view showing the configuration of a second divisional core of the core plate of the stator core shown in FIG. 2. FIG. 6 is a plan view showing the configuration of a fastening-portion-less divisional core of the core plate of the stator core shown in FIG. 2.

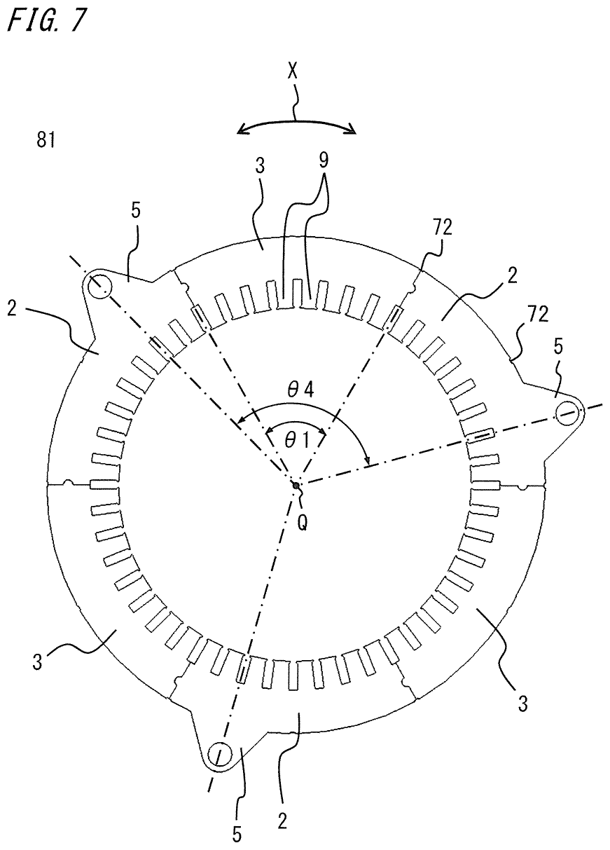

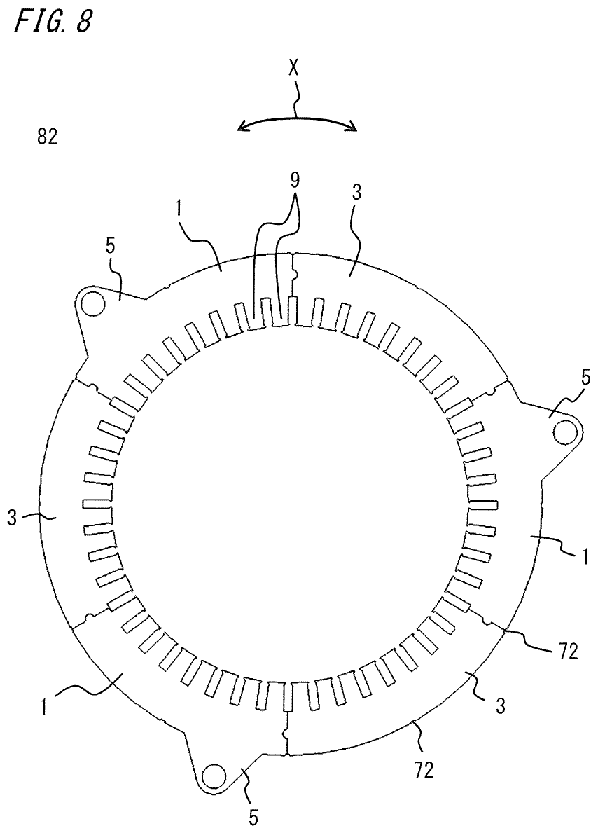

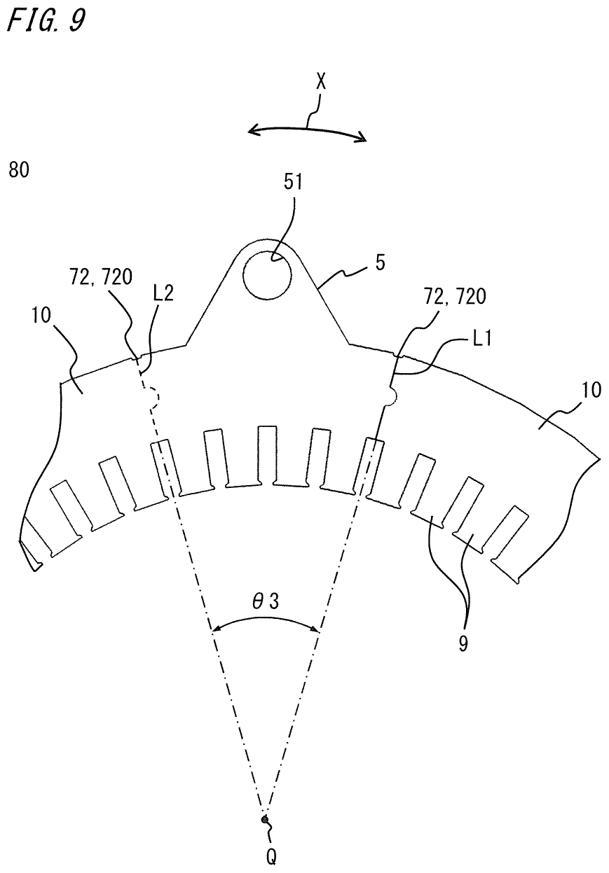

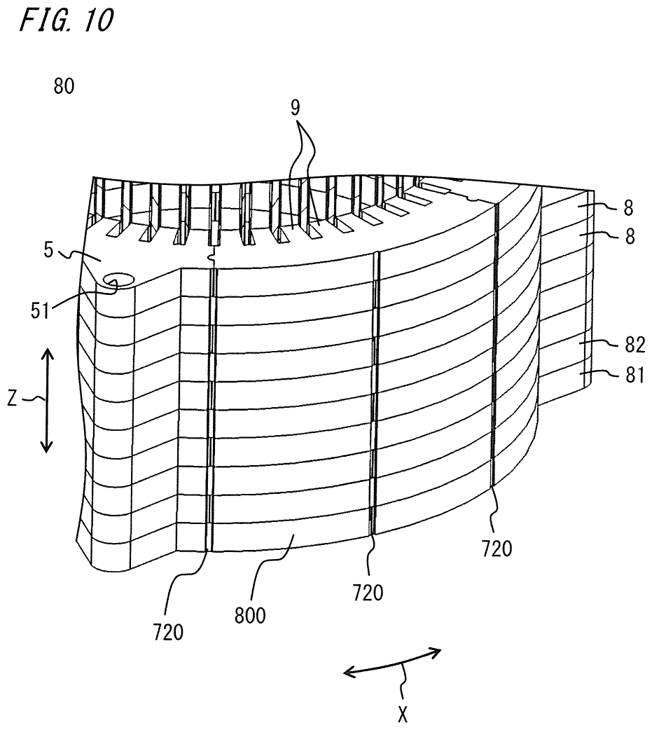

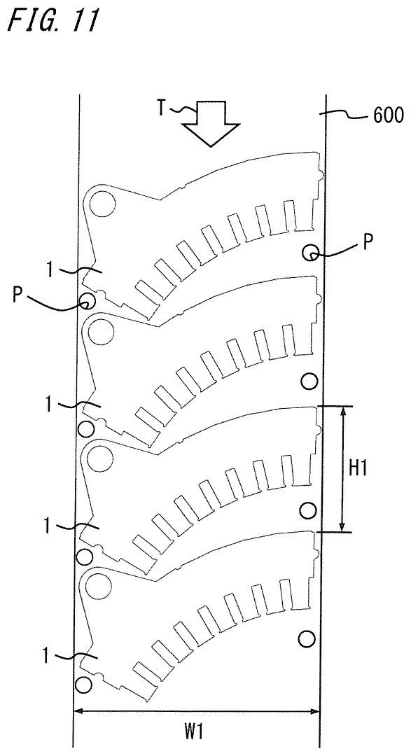

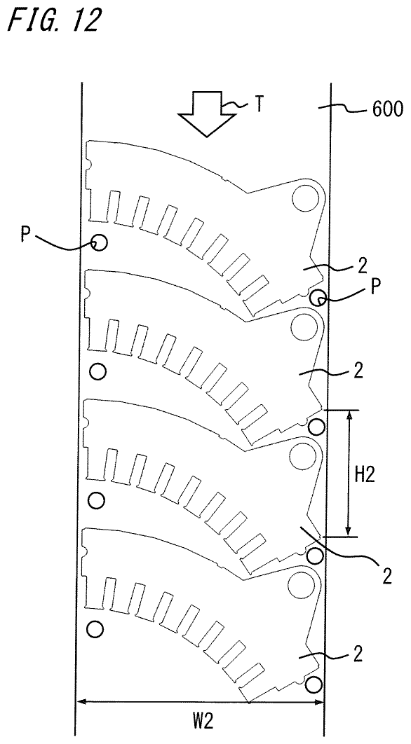

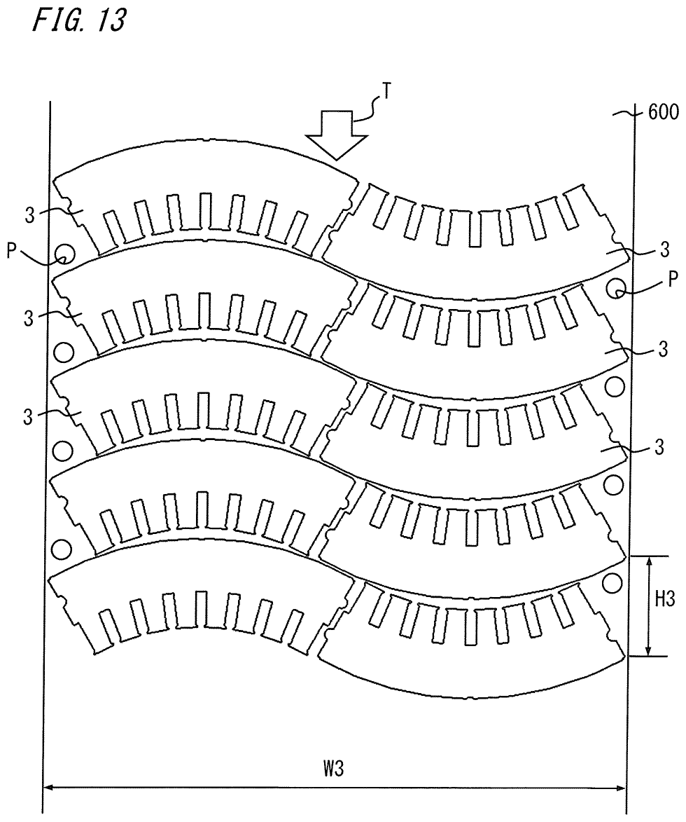

FIG. 7 is a plan view showing the configuration of a first-stage core plate of the stator core shown in FIG. 2. FIG. 8 is a plan view showing the configuration of a second-stage core plate of the stator core shown in FIG. 2. FIG. 9 is a plan view showing the configuration of a part of the stator core shown in FIG. 2. FIG. 10 is a perspective view showing the configuration of a part of the stator core shown in FIG. 2. FIG. 11 is a plan view showing a manufacturing method for the first divisional core shown in FIG. 4. FIG. 12 is a plan view showing a manufacturing method for the second divisional core shown in FIG. 5. FIG. 13 is a plan view showing a manufacturing method for the fastening-portion-less divisional core shown in FIG. 6.

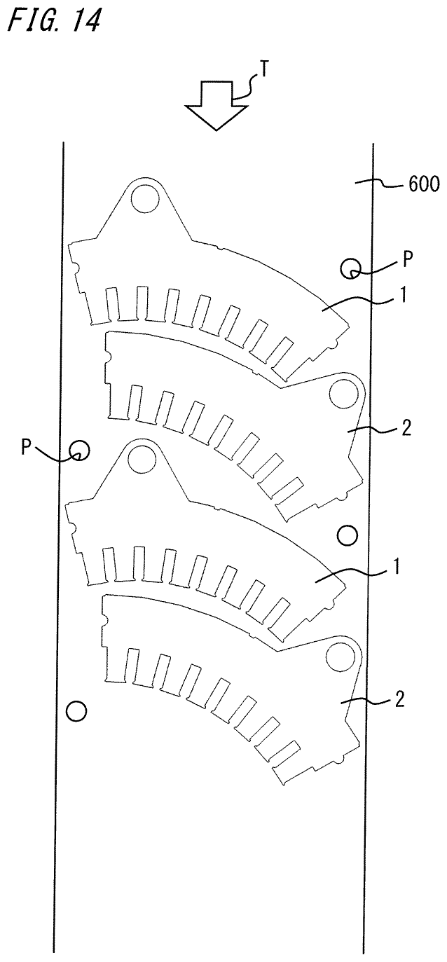

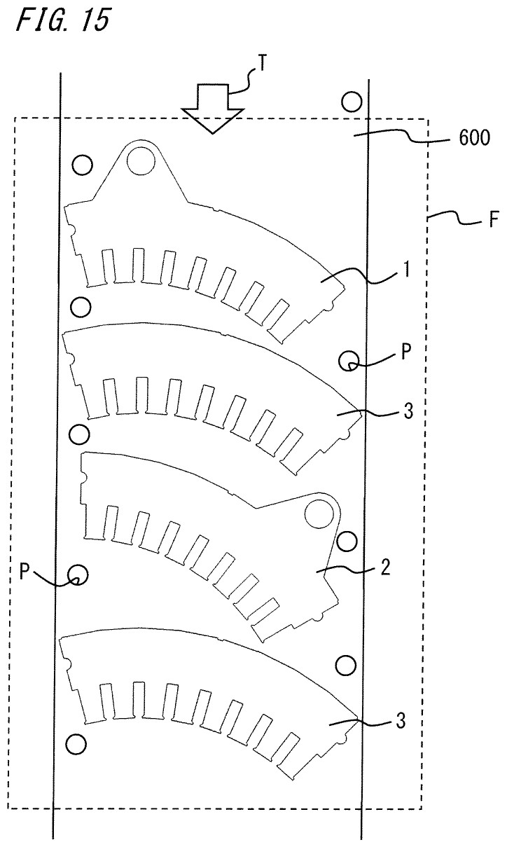

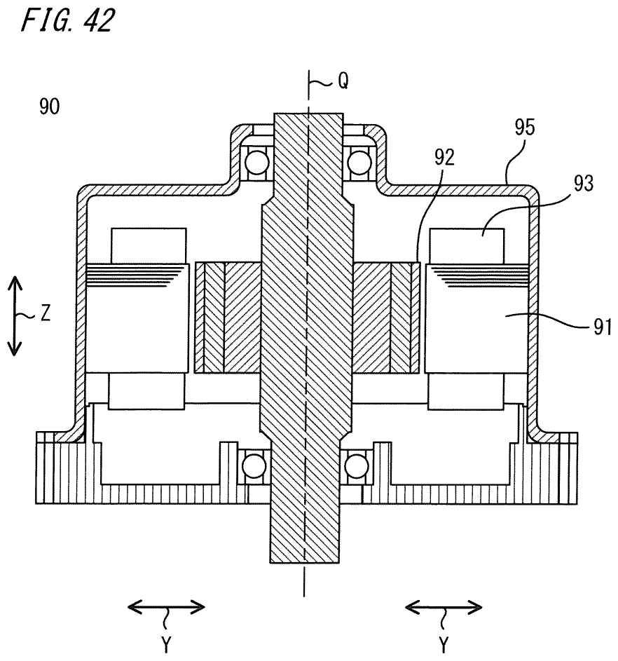

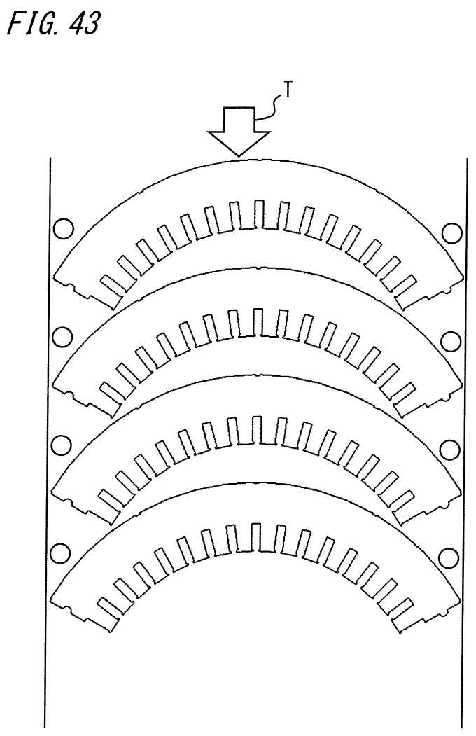

FIG. 14 is a plan view showing a manufacturing method for the first divisional core and the second divisional core shown in FIG. 4 and FIG. 5. FIG. 15 is a plan view showing a manufacturing method for the first divisional core, the second divisional core, and the fastening-portion-less divisional core shown in FIG. 4, FIG. 5, and FIG. 6. FIG. 42 is a vertical sectional view showing the configuration of the rotating electrical machine according to each embodiment. FIG. 43 is a plan view showing a comparative example in a manufacturing method for divisional cores of which the division number is three.

The present embodiment 1 will be described with reference to the drawings. As shown in FIG. 42, a rotating electrical machine 90 includes a stator 91 and a rotor 92 rotatably provided so as to be opposed to the stator 91 with a gap therebetween. The stator 91 is fixed to a frame 95. The rotor 92 rotates about a rotation center axis Q.

As shown in FIG. 1, the stator 91 of the rotating electrical machine 90 includes a stator core 80 and a coil 93 formed by a conductor which is a copper wire, for example, in slots located between teeth 9 in the circumferential direction X of the stator core 80 with insulators (insulating sheets) 94 therebetween. In FIG. 1, the coil 93 is formed by a rectangular wire as an example. However, the coil 93 may be formed by a copper round wire, an aluminum wire, or the like. At one end in the axial direction Z of the coil 93 (in FIG. 1, a lower end), a terminal portion 931 where coating-removed parts are joined to each other is formed and thus a circuit of the rotating electrical machine 90 shown in FIG. 42 is formed.

As shown in FIG. 2, the stator core 80 is formed by stacking a plurality of core plates 8 which are thin plates (plate thickness: 0.25 mm to 0.3 mm or smaller) such as electromagnetic steel sheets, in the axial direction Z. Therefore, the axial direction Z corresponds to the stacking direction. Among the core plates 8, in particular, the core plate 8 at the first stage in the axial direction Z, i.e., at the lowest position in the drawing of FIG. 2, is referred to as a first-stage core plate 81, and the second core plate 8 from the lowest position in the drawing of FIG. 2, i.e., the core plate 8 immediately above the first-stage core plate 81 in the axial direction Z in the drawing of FIG. 2, is referred to as a second-stage core plate 82. When any core plate is indicated, the core plate is merely referred to as a core plate 8 in the drawings and the description. The same applies to the other embodiments below.

As shown in FIG. 3, the stator core 80 has a plurality of teeth 9 formed at equal intervals in the circumferential direction X and extending inward in the radial direction Y from the inner circumferential surface of the core plate 8, and is divided in the circumferential direction X, and divisional cores 10 of which a division number N (N being an integer) is four more, here, the division number N=6, i.e., six divisional cores 10 are arranged in contact with each other in the circumferential direction X. The divisional cores 10 include a plurality of kinds of divisional cores, as described later. However, when any divisional core is mentioned, the divisional core is merely referred to as a divisional core 10 in the drawings and the description. The same applies to the other embodiments below.

As shown in FIG. 2 and FIG. 3, each core plate 8 composing the stator core 80 has, at an outer circumferential surface 800, fastening portions 5 protruding outward in the radial direction Y and having fastening holes 51 for fastening the core plates 8 to each other in the axial direction Z. A number M (M being an integer) of the fastening portions 5 of the core plate 8 in the circumferential direction X is three or more. In this example, the number M of the fastening portions 5 of the core plate 8 is three. Thus, a relationship of N≥M is satisfied, and in particular, a relationship of N>M is satisfied.

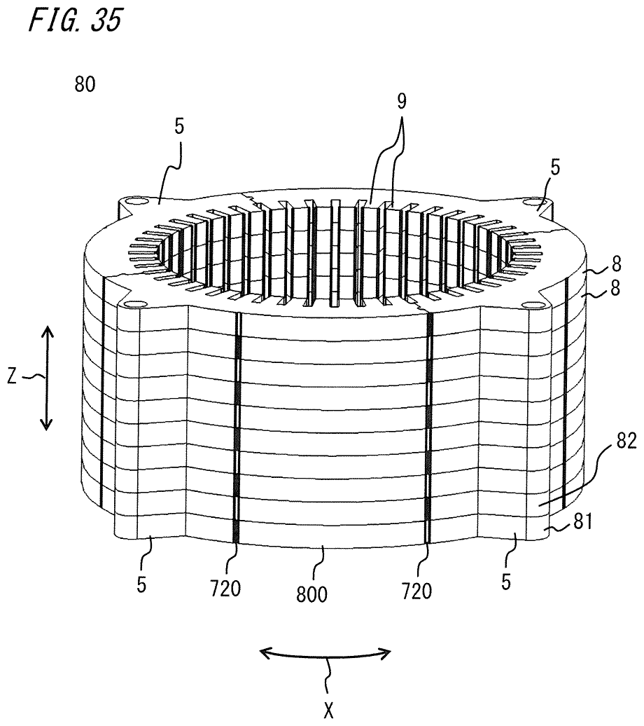

The fastening holes 51 of the fastening portions 5 are used as through holes for fastening the stator core 80 to the frame 95 as shown in FIG. 35. In the vicinity of the fastening hole 51 of the fastening portion 5, a thick portion or the like for ensuring rigidity of the fastening portion 5 may be formed. Regarding the fastening portion 5 and the fastening hole 51, the same applies to description of the stator core 80, the core plate 8, and the corresponding divisional core 10 shown below.

As shown in FIG. 3, the division number N is 6 and the divisional cores 10 are equally divided in the circumferential direction. Therefore, an angle θ1 of one divisional core 10 is 60 degrees (see angle θ1 in FIG. 4). The fastening portions 5 are arranged at intervals of 360 degrees/M=120 degrees (see angle θ4 in FIG. 7).

In the present embodiment 1, the divisional cores 10 include three kinds of divisional cores 10. The three kinds of divisional cores 10 are a first divisional core 1 and a second divisional core 2 as a plurality of kinds of fastening-portion-provided divisional cores of which the fastening portions 5 are provided at a plurality of different positions separated from a center line Q1 connecting the rotation center axis Q of the rotating electrical machine 90 and the center in the circumferential direction X of each divisional core 10, and a fastening-portion-less divisional core 3 not having the fastening portion 5.

Hereinafter, each of the three kinds of divisional cores 10 will be described. As shown in FIG. 4, the first divisional core 1 has the fastening portion 5 at a position separated from the center line Q1 connecting the rotation center axis Q and the center in the circumferential direction X of the divisional core 10, here, at a position of an angle θ21 leftward on the drawing. Specifically, the angle θ21 is 15 degrees. A length D1 from the rotation center axis Q to an outer circumferential surface 100 of the first divisional core 1 corresponds to the radius of the core plate 8. The fastening portion 5 is formed to protrude outward in the radial direction Y from the outer circumferential surface 100 by a length D2 from the length D1. The relationship between the length D1 and the length D2 applies in the same manner below and therefore the description thereof is omitted as appropriate.

The outer circumferential surface 100 of the first divisional core 1 has outer-circumference recesses 72 on the center line Q1 and at both ends in the circumferential direction X. The outer-circumference recesses 72 are used for positioning or for welding the core plates 8 to each other in the axial direction Z. A projection 111 is formed at a one-side contact portion 101 which contacts with another divisional core 10 in the circumferential direction X of the first divisional core 1, and a recess 112 is formed at an other-side contact portion 102. The projection 111 and the recess 112 are used for positioning in the radial direction Y between the respective kinds of divisional cores 10, discrimination between the front side and the back side, and the like.

Next, as shown in FIG. 5, the second divisional core 2 has the fastening portion 5 at a position separated from the center line Q1 connecting the rotation center axis Q and the center in the circumferential direction X of the divisional core 10, here, at a position of an angle θ22 rightward on the drawing. Specifically, the angle θ22 is 15 degrees. Thus, the fastening portion 5 of the first divisional core 1 and the fastening portion 5 of the second divisional core 2 are formed at line-symmetric positions with respect to the center line Q1.

An outer circumferential surface 200 of the second divisional core 2 has outer-circumference recesses 72 on the center line Q1 and at both ends in the circumferential direction X. The outer-circumference recesses 72 are used for positioning or for welding the core plates 8 to each other in the axial direction Z. A projection 211 is formed at a one-side contact portion 201 which contacts with another divisional core 10 in the circumferential direction X of the second divisional core 2, and a recess 212 is formed at an other-side contact portion 202. The projection 211 and the recess 212 are used for positioning in the radial direction Y between the respective kinds of divisional cores 10, discrimination between the front side and the back side, and the like.

Next, as shown in FIG. 6, the fastening-portion-less divisional core 3 does not have the fastening portion 5. An outer circumferential surface 300 of the fastening-portion-less divisional core 3 has outer-circumference recesses 72 on the center line Q1 and at both ends in the circumferential direction X. The outer-circumference recesses 72 are used for positioning or for welding the core plates 8 to each other in the axial direction Z. A projection 311 is formed at a one-side contact portion 301 which contacts with another divisional core 10 in the circumferential direction X of the fastening-portion-less divisional core 3, and a recess 312 is formed at an other-side contact portion 302. The projection 311 and the recess 312 are used for positioning in the radial direction Y between the respective kinds of divisional cores 10, discrimination between the front side and the back side, and the like.

As shown in FIG. 7, the first-stage core plate 81 of the stator core 80 is formed by arranging the second divisional cores 2 and the fastening-portion-less divisional cores 3 alternately in the circumferential direction X. As shown in FIG. 8, the second-stage core plate 82 of the stator core 80 is formed by arranging the first divisional cores 1 and the fastening-portion-less divisional cores 3 alternately in the circumferential direction X. In the stator core 80, the first-stage core plates 81 and the second-stage core plates 82 are sequentially stacked in the axial direction Z.

The core plates 8 formed by arranging the first divisional cores 1, the second divisional cores 2, and the fastening-portion-less divisional cores 3 as shown in the first-stage core plate 81 and the second-stage core plate 82, are sequentially stacked in the axial direction Z, whereby the fastening portions 5 of different kinds of divisional cores 10, i.e., the fastening portions 5 of the first divisional cores 1 and the fastening portions 5 of the second divisional cores 2, are stacked on the upper and lower sides in the axial direction Z.

Thus, between the upper and lower sides in the axial direction Z, as shown in FIG. 3 and FIG. 9, on the upper side in the axial direction Z, contact parts L1 in the circumferential direction X between the divisional cores 10 are formed at six locations, and on the lower side in the axial direction Z, contact parts L2 are formed at six locations at lapped positions indicated by dotted lines, which are shifted in the circumferential direction X from the above contact parts L1. Accordingly, the contact parts L1 and the contact parts L2 are formed in a lapping manner in the axial direction Z (stacking direction) with an angle θ3=30 degrees which is half the angle θ1 of the divisional core 10.

Therefore, when the core plates 8 are stacked, the first-stage core plate 81 and the second-stage core plate 82 may be stacked sequentially at third and subsequent stages, and thus, in the same manner as the stacking relationship between the first-stage core plate 81 and the second-stage core plate 82 described above, the fastening portions 5 and the fastening holes 51 are located so as to overlap each other in the axial direction Z, whereby attachment parts that can be fastened to the frame 95 can be formed. In addition, since the stator core 80 is formed with the contact parts L1 and the contact parts L2 lapped (brick-stacking state) in a staggered manner in the axial direction Z, rigidity of the stator core 80 can be ensured.

In addition, since the first divisional core 1, the second divisional core 2, and the fastening-portion-less divisional core 3 each have the outer-circumference recesses 72 on the center line Q1 and at both ends in the circumferential direction X, the stator core 80 has grooves 720 formed contiguously in the axial direction Z by the outer-circumference recesses 72 on the outer circumferential surface 800, as shown in FIG. 2 and FIG. 10.

At this time, the core plates 8 are fastened by swaging, welding, bonding, or the like so as to be fixed to each other in the axial direction Z (stacking direction). If bonding is used, rigidity of the stator 91 is more obtained, and therefore welding described later need not be performed. In a case of using means other than bonding, welding is performed at the grooves 720 in the axial direction Z described above. Using the grooves 720 as described above can suppress swelling of beads in welding in the axial direction Z. The grooves 720 can be used also for positioning of the divisional cores 10. For welding, a general method such as laser welding is used. The configurations of the outer-circumference recesses 72 and the grooves 720 are the same also in the other embodiments below and therefore the description thereof is omitted as appropriate.

Next, regarding manufacturing methods for the first divisional core 1, the second divisional core 2, and the fastening-portion-less divisional core 3, relationships with the material yield will be described with reference to FIG. 11 to FIG. 15. As shown in the drawings, in a thin plate 600 (plate thickness: 0.25 mm to 0.3 mm or smaller) such as an electromagnetic steel sheet for manufacturing the divisional cores 10, the divisional cores 10 and pilot holes P used for positioning in stamping are arranged so as to minimize areas that are not used for products. The feeding direction of the thin plate 600 is indicated by an arrow T. In general, increasing the division number can reduce the areas (ineffective areas) that are not used for products. In addition, in a case where the division number is six, one divisional core 10 can be made small, and therefore a plurality of divisional cores 10 can be arranged in a staggered manner on a steel sheet, whereby the material yield can be further improved.

FIG. 11 shows die arrangement positions for the first divisional cores 1. A material width is W1 and a feed pitch is H1. FIG. 12 shows die arrangement positions for the second divisional cores 2. A material width is W2 and a feed pitch is H2. In a case of manufacturing the first divisional cores 1 and the second divisional cores 2 in this way, the material yield is approximately 60%. FIG. 13 shows a die placement configuration for the fastening-portion-less divisional cores 3. A material width is W3 and a feed pitch is H3. In a case of manufacturing the fastening-portion-less divisional cores 3 in this way, the material yield is approximately 73%.

As described above, the material yield for the fastening-portion-less divisional core 3 not having the fastening portion 5 is higher than the material yields for the first divisional core 1 and the second divisional core 2. Therefore, even in the case of including the first divisional core 1 and the second divisional core 2 which have the fastening portions 5, the material yield for the entire stator core 80 can be improved. In a case of a comparative example in which the division number N is three as shown in FIG. 43, the material yield is approximately 58.3%, whereas in the case of the divisional core 10 in the present embodiment, the arc shape thereof is small and therefore the material yield is high, so that the material can be effectively used.

As shown in FIG. 11 to FIG. 13, the pilot holes P are formed in ineffective areas which are not used for products of the divisional cores 10, and the divisional cores 10 can be arranged in a state in which the material yield is optimum, whereby size reduction of the die, high-speed press stamping, and multiple-piece production of the divisional cores 10 can be achieved, so that productivity can also be improved. Arrangements in FIG. 11 to FIG. 13 are merely examples, and other arrangements may be adopted as long as the material yield is not lowered.

Other examples of manufacturing methods will be described with reference to FIG. 14 and FIG. 15. As shown in FIG. 14, with respect to an arrow T in the feeding direction, the first divisional cores 1 and the second divisional cores 2 are arranged alternately such that the fastening portions 5 do not overlap at the same locations in the width direction of the thin plate 600. In this case, the material yield is approximately 59%. As shown in FIG. 15, manufacturing may be performed such that the first divisional cores 1 and the second divisional cores 2 are arranged together with the fastening-portion-less divisional cores 3 sequentially with respect to an arrow T.

For example, in a case of providing dies for the first divisional core and the second divisional core individually, two dies are needed. In this case, one press machine is used per one die, resulting in increase in equipment cost and working cost. On the other hand, in a case of manufacturing as shown in FIG. 14 and FIG. 15, it becomes possible to stamp the first divisional core 1 and the second divisional core 2 having different shapes by one die or stamp the first divisional core 1, the second divisional core 2, and the fastening-portion-less divisional core 3 having different shapes by one die (a part F enclosed by a dotted line in FIG. 15 is a part where stamping is performed by one die), without reducing the material yield, i.e., the different-shape divisional cores can be arranged and stamped by the same die, while the pilot holes P can be arranged.

As long as the die size is not large, it is unnecessary to use a large-sized press machine. In addition, a small-sized press machine can be used, so that the press speed can be increased. Thus, a plurality of kinds of core shapes can be collected in one die, so that both of material yield improvement and high-speed press can be achieved, leading to production improvement.

The core plate 8 is formed using the first divisional core 1 and the second divisional core 2 of which the fastening portions 5 are provided at a plurality of different positions separated from the center line Q1 connecting the rotation center axis Q and the circumferential-direction center of each divisional core 10. Therefore, by setting the formation positions of the fastening portion 5 of the first divisional core 1 and the fastening portion 5 of the second divisional core 2 as appropriate, the positions of the fastening portions 5 in the core plate 8 can be set as appropriate, and thus freedom of the providing positions of the fastening portions 5 is improved.

The stator core for the rotating electrical machine according to embodiment 1 configured as described above is formed by stacking a plurality of core plates in an axial direction. Each core plate has a plurality of teeth and is divided in a circumferential direction, and is formed such that divisional cores of which a division number N (N being an integer) is four or more are arranged in contact with each other in the circumferential direction. The core plate has, on an outer circumferential side thereof, fastening portions protruding outward in a radial direction and having fastening holes for fastening the core plates in a stacking direction. A number M (M being an integer) of the fastening portions in the circumferential direction is three or more, and a relationship of N≥M is satisfied. The divisional cores include a plurality of kinds of fastening-portion-provided divisional cores of which the fastening portions are provided at a plurality of different positions separated from a center line connecting a rotation center axis of the rotating electrical machine and a circumferential-direction center of each divisional core. The fastening portions of different kinds of the fastening-portion-provided divisional cores are stacked on upper and lower sides in the stacking direction. The core plates are stacked such that contact parts of the divisional cores are located at positions different in the circumferential direction on the upper and lower sides in the stacking direction. The fastening holes of the fastening portions are formed in communication with each other in the stacking direction.

The stator according to embodiment 1 configured as described above includes: the stator core for the rotating electrical machine described above; and a coil wound around the teeth of the stator core with an insulator therebetween. A relationship of N>M is satisfied. The divisional cores include a fastening-portion-less divisional core not having the fastening portion.

The rotating electrical machine according to embodiment 1 configured as described above includes: the stator described above; and a rotor rotatably provided so as to be opposed to the stator with a gap therebetween.

Thus, since the divisional cores include a plurality of kinds of fastening-portion-provided divisional cores of which the fastening portions are provided at a plurality of different positions separated from the center line connecting the rotation center axis of the rotating electrical machine and the circumferential-direction center of each divisional core, both of material yield improvement and freedom in designing of the fastening portion can be achieved.

In addition, since the core plates are stacked such that the contact parts of the divisional cores are located at positions different in the circumferential direction on the upper and lower sides in the stacking direction, and thus have a lapping structure, rigidity of the stator core and fixation strength of the stator core can be ensured even though the stator core is formed by divisional cores.

In addition, since the core plate is formed by a plurality of divisional cores, an electromagnetic steel sheet different from that for the rotor (different in material, plate thickness, etc.) can be used, and thus it becomes possible to achieve both of material yield improvement and selection of a material and a steel sheet that are suitable in terms of performance.

In conventional art, the division number of the core plate cannot be increased, and therefore the die size is large. Further, along with this, a press machine on which the die is to be put becomes large, and the press speed is limited. In contrast, according to the present embodiment 1, the division number of the core plate can be increased and the die size can be reduced. Thus, the working speed is increased, so that productivity can be improved owing to size reduction and speed increase of the press machine and size reduction of the die.

Further, in the stator core for the rotating electrical machine according to embodiment 1 configured as described above, as the fastening-portion-provided divisional cores, at least two kinds of fastening-portion-provided divisional cores are provided, one of the two kinds being defined as a first divisional core and another one being defined as a second divisional core, and the fastening portion of the first divisional core and the fastening portion of the second divisional core are formed at line-symmetric positions with respect to the center line.

Thus, both of material yield improvement and freedom in designing of the fastening portion can be easily achieved.

Further, in the stator core for the rotating electrical machine according to embodiment 1 configured as described above, the division number N of the core plate is set at N=6, the number M of the fastening portions is set at M=3 or M=4, and the fastening portions are arranged at intervals of (360 degrees/M) in the circumferential direction.

Thus, both of material yield improvement and freedom in designing of the fastening portion can be easily and assuredly achieved.

Further, in the stator core for the rotating electrical machine according to embodiment 1 configured as described above, the divisional cores are fixed by being bonded to each other, in the stacking direction.

Thus, the core plates can be strongly fixed in the stacking direction, whereby rigidity of the stator core is improved.

In addition, since fixation is performed by bonding, deviations among the plate thicknesses of the core plates can be equalized, so that the thickness in the stacking direction of the stator core is stabilized.

In addition, welding for fixation may become unnecessary.

Further, in the stator core for the rotating electrical machine according to embodiment 1 configured as described above, the core plates have, on outer circumferential surfaces thereof, outer-circumference recesses formed at such positions that the outer-circumference recesses extend contiguously in the stacking direction.

Thus, a plurality of kinds of divisional cores can be easily arranged, and assemblability is improved.

Further, in the stator core for the rotating electrical machine according to embodiment 1 configured as described above, a welding portion for fixing the divisional cores in the stacking direction is provided at a groove formed by the outer-circumference recesses extending contiguously in the stacking direction.

Conventionally, due to presence of the fastening portions, it has been impossible to provide a groove for suppressing swelling of welding beads in welding for fixing contact parts between stacked layers.

However, since the welding portion can be formed at the groove, swelling of beads can be suppressed in welding.

Further, in the stator core for the rotating electrical machine according to embodiment 1 configured as described above, the divisional cores of each core plate are formed so as to be equally divided in the circumferential direction.

Thus, both of material yield improvement and freedom in designing of the fastening portion can be assuredly achieved.

### Embodiment 2

In the above embodiment 1, the example in which the division number N is six and the number M of the fastening portions 5 is three, has been shown. However, without limitation thereto, in the present embodiment 2, a case where the division number N is six and the number M of the fastening portions 5 is four will be described. The same parts as those in the above embodiment 1 are denoted by the same reference characters and the description thereof is omitted as appropriate. Here, difference from the above embodiment 1 will be mainly described.

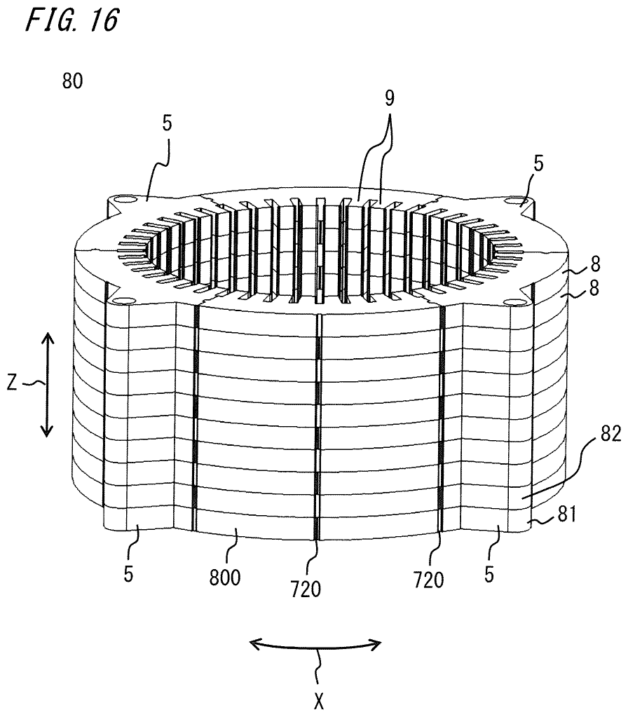

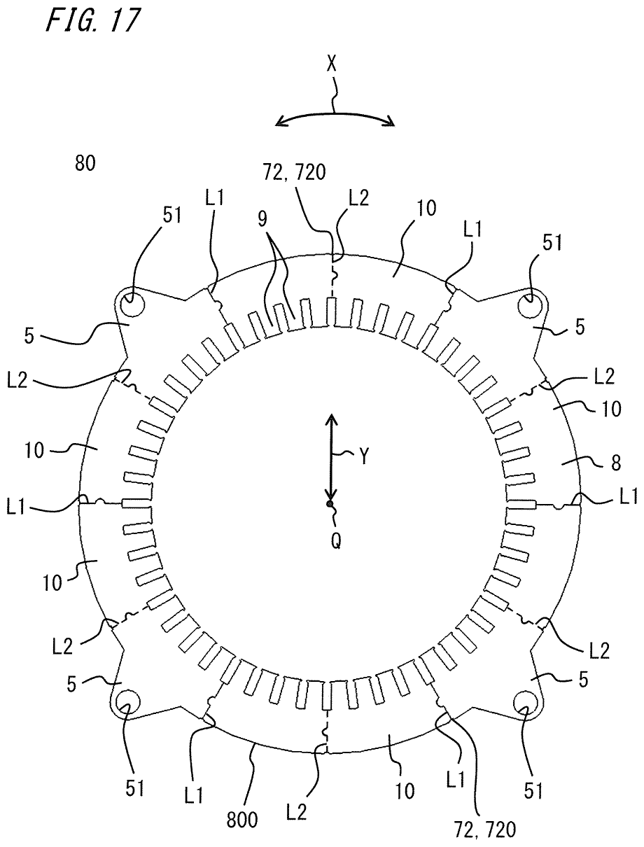

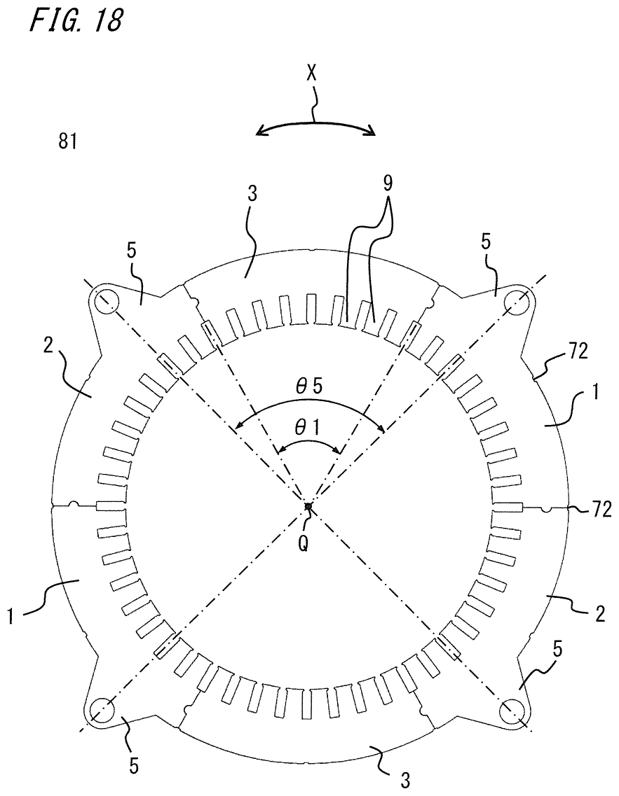

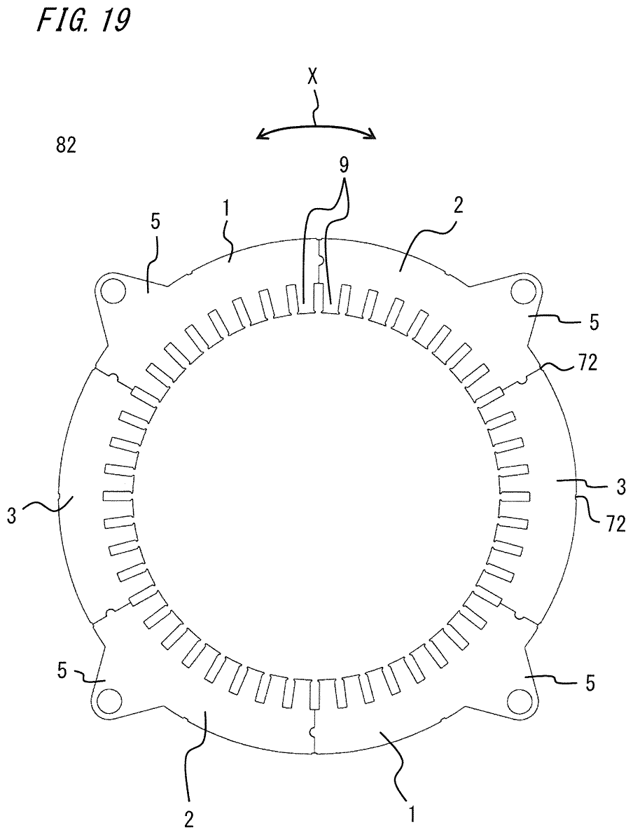

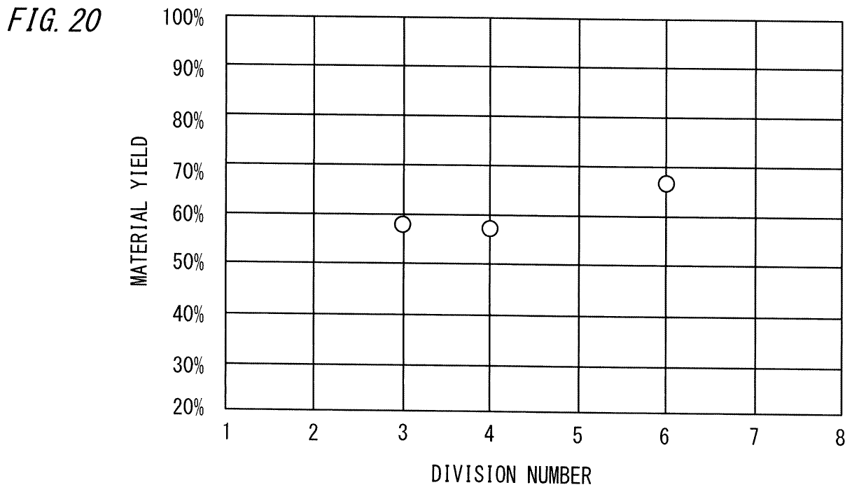

FIG. 16 is a perspective view showing the configuration of a stator core for a rotating electrical machine according to embodiment 2. FIG. 17 is a plan view showing the configuration of the stator core shown in FIG. 16. FIG. 18 is a plan view showing the configuration of a first-stage core plate of the stator core shown in FIG. 16. FIG. 19 is a plan view showing the configuration of a second-stage core plate of the stator core shown in FIG. 16. FIG. 20 is a graph showing the relationship between the material yield and the division number of the divisional cores.

The present embodiment 2 will be described with reference to the drawings. As shown in FIG. 16, a stator core 80 has the fastening portions 5 of which the number M is four in the circumferential direction X. Therefore, the fastening portions 5 are arranged at intervals of 360 degrees/M=90 degrees (see angle θ5 in FIG. 17). As shown in FIG. 17, the core plate 8 of the stator core 80 is formed such that a plurality of divisional cores 10 of which the division number N is six are arranged in an annular shape, as in the above embodiment 1. In the present embodiment 2, the divisional cores 10 include three kinds of divisional cores 10, i.e., the first divisional core 1, the second divisional core 2, and the fastening-portion-less divisional core 3, as in the above embodiment 1.

Specifically, as shown in FIG. 18, the first-stage core plate 81 has the first divisional core 1, the second divisional core 2, the fastening-portion-less divisional core 3, the first divisional core 1, the second divisional core 2, and the fastening-portion-less divisional core 3 arranged in contact with each other in this order in the circumferential direction X. In addition, as shown in FIG. 19, the second-stage core plate 82 has the first divisional core 1, the second divisional core 2, the fastening-portion-less divisional core 3, the first divisional core 1, the second divisional core 2, and the fastening-portion-less divisional core 3 arranged in contact with each other in this order in the circumferential direction X.

In the stator core 80, the first-stage core plates 81 and the second-stage core plates 82 are sequentially stacked in the axial direction Z. The core plates 8 formed by arranging the first divisional cores 1, the second divisional cores 2, and the fastening-portion-less divisional cores 3 as shown above in the first-stage core plate 81 and the second-stage core plate 82, are sequentially stacked in the axial direction Z, whereby the fastening portions 5 of different kinds of divisional cores 10, i.e., the fastening portions 5 of the first divisional cores 1 and the fastening portions 5 of the second divisional cores 2, are stacked on the upper and lower sides in the axial direction Z.

Thus, between the upper and lower sides in the axial direction Z, as shown in FIG. 17, as in the above embodiment 1, on the upper side in the axial direction Z, contact parts L1 in the circumferential direction X between the divisional cores 10 are formed at six locations, and on the lower side in the axial direction Z, contact parts L2 are formed at six locations at lapped positions indicated by dotted lines, which are shifted in the circumferential direction X from the above contact parts L1. Accordingly, the contact parts L1 and the contact parts L2 are formed in a lapping manner in the axial direction Z (stacking direction) with an angle θ3=30 degrees (see FIG. 9) which is half the angle θ1 of the divisional core 10.

Therefore, when the core plates 8 are stacked, the first-stage core plate 81 and the second-stage core plate 82 may be stacked sequentially at third and subsequent stages, and thus, in the same manner as the stacking relationship between the first-stage core plate 81 and the second-stage core plate 82 described above, the fastening portions 5 and the fastening holes 51 are located so as to overlap each other in the axial direction Z, whereby attachment parts that can be fastened to the frame 95 can be formed. In addition, since the stator core 80 is formed with the contact parts L1 and the contact parts L2 lapped (brick-stacking state) in a staggered manner in the axial direction Z, rigidity of the stator core 80 can be ensured.

Here, the relationship between the total material yield and the division number N of the divisional cores 10 is shown in FIG. 20. As shown in the graph, when the division number N is six, the material yield is improved. In the case where the division number N is increased to six as described above, setting of shapes such as the fastening portions 5 and arrangement of the divisional cores 1, 2, and 3 are performed as shown in the above embodiment 1 or 2, whereby the material yield can be improved. As a result, it is possible to form the stator core 80 for which the material yield is improved, even in a case where the division number is the same and the number of the fastening portions 5 is different.

Thus, it is possible to form the stator core 80 having the fastening portions 5, without reducing the material yield. In addition, since the divisional cores 10 can be arranged in a lapping state in the axial direction Z, it is possible to form the stator core 80 having the fastening portions 5 without reducing rigidity of the stator core 80.

In the stator core for the rotating electrical machine, the stator, and the rotating electrical machine according to embodiment 2 configured as described above, the same effects as in the above embodiment 1 are provided, and in addition, the fastening portions can be freely configured and designed even in a case of using the same number of kinds of divisional cores. Thus, while using the same die, it is possible to change arrangement and the number of the fastening portions just by combination. Since another die is not needed, it is possible to change the fastening portions without reducing the material yield.

### Embodiment 3

In the present embodiment 3, an example in which the division number N is different from those in the above embodiments will be described. Specifically, the division number N is four and the number M of the fastening portions 5 is three. The same parts as those in the above embodiments are denoted by the same reference characters and the description thereof is omitted as appropriate. Here, difference from the above embodiments will be mainly described.

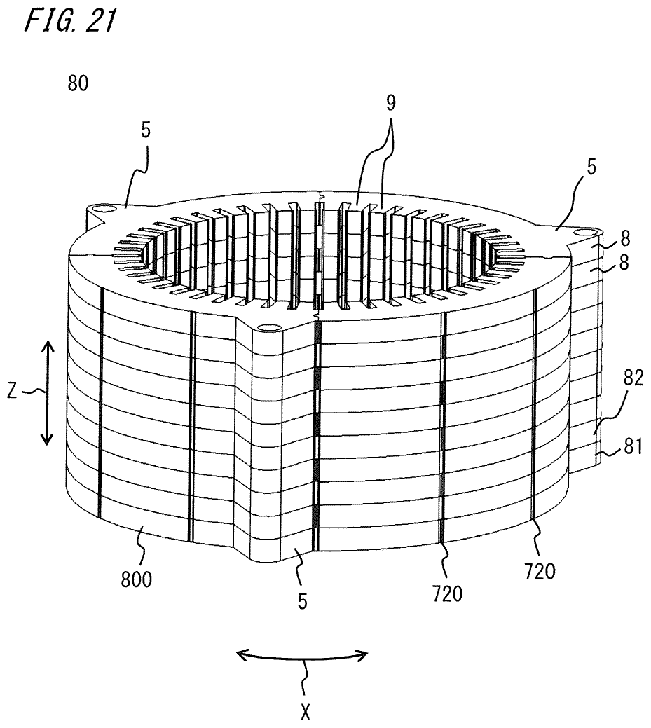

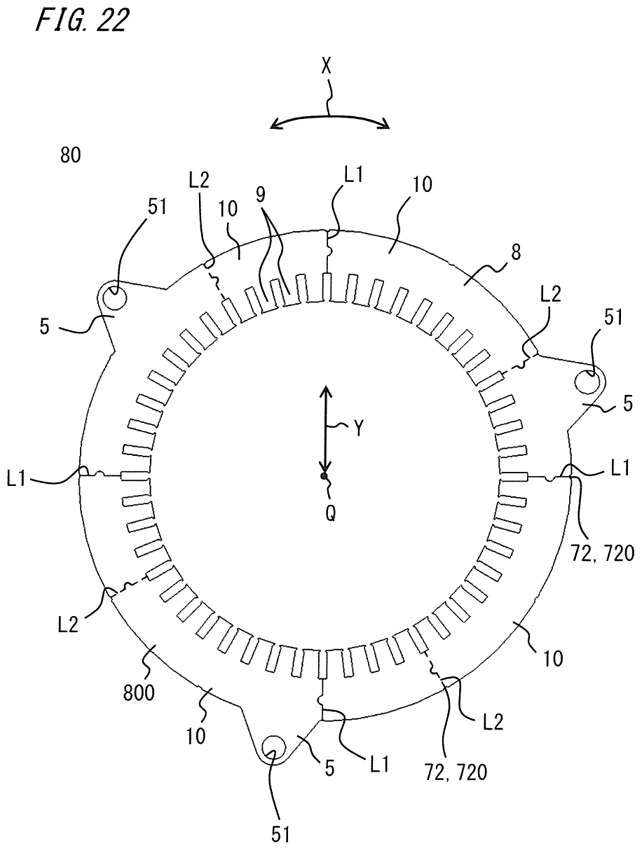

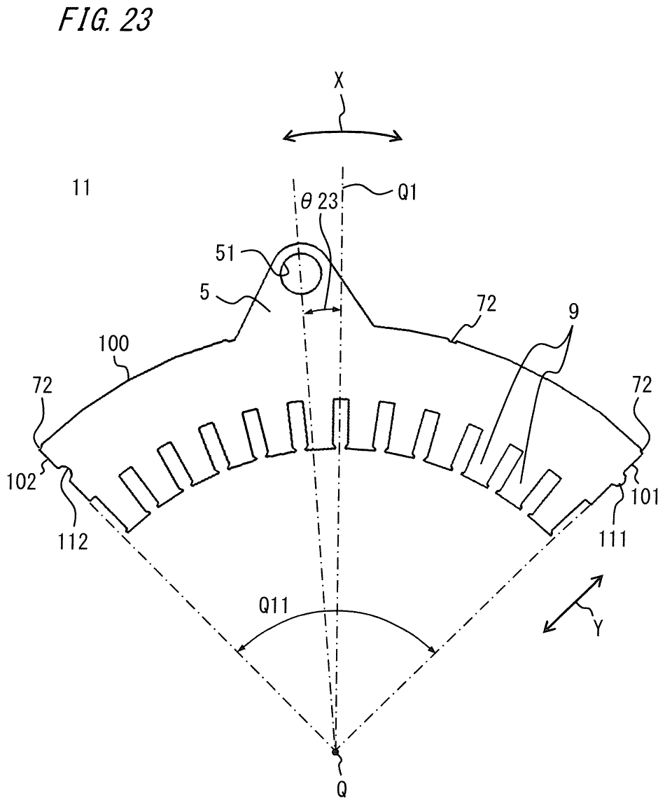

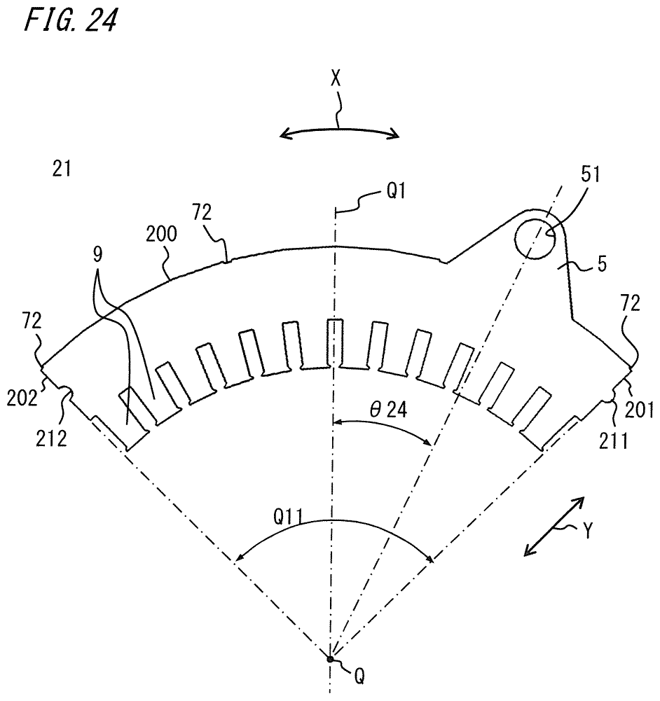

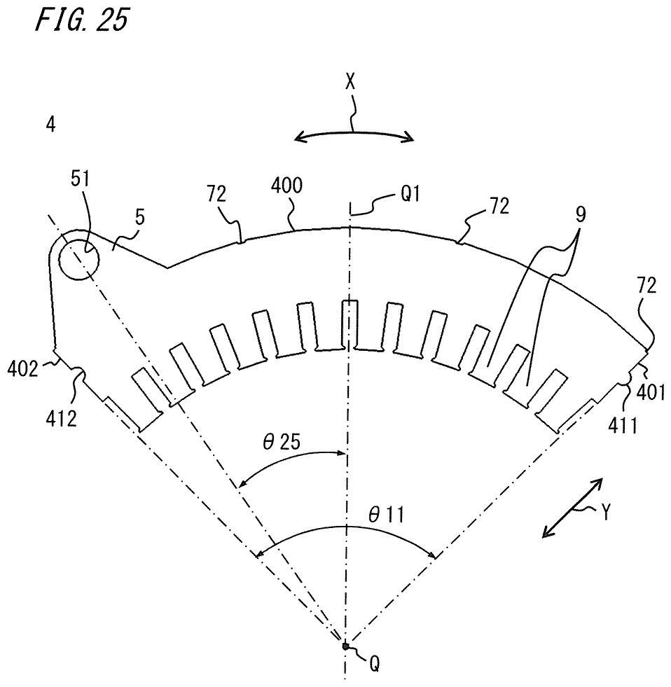

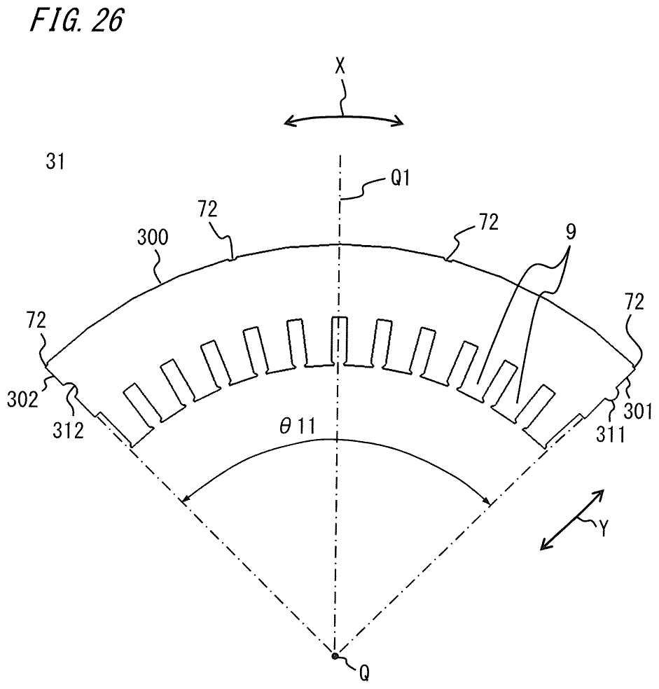

FIG. 21 is a perspective view showing the configuration of a stator core of a rotating electrical machine according to embodiment 3. FIG. 22 is a plan view showing a configuration of the stator core shown in FIG. 21. FIG. 23 is a plan view showing a configuration of a first divisional core of the stator core shown in FIG. 22. FIG. 24 is a plan view showing the configuration of a second divisional core of the stator core shown in FIG. 22. FIG. 25 is a plan view showing the configuration of a third divisional core of the stator core shown in FIG. 22. FIG. 26 is a plan view showing the configuration of a fastening-portion-less divisional core of the stator core shown in FIG. 22.

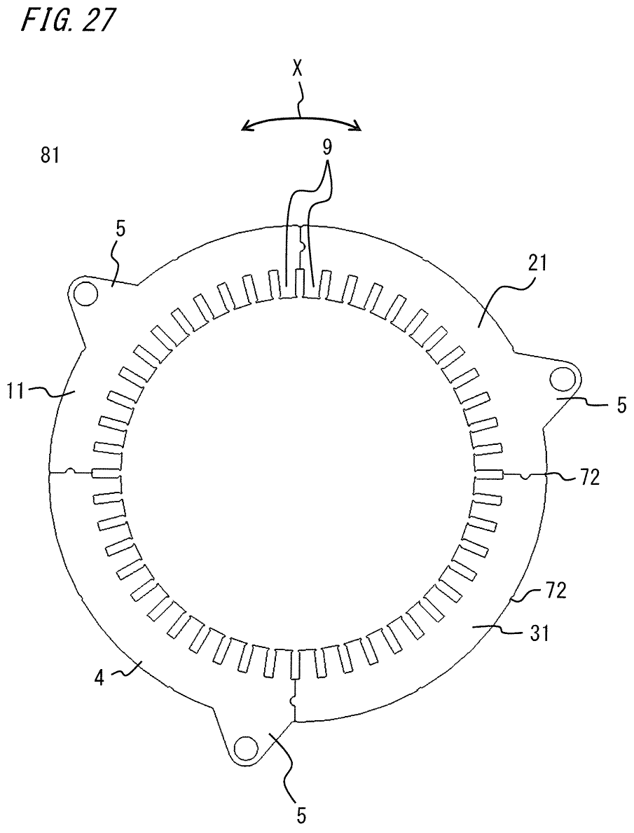

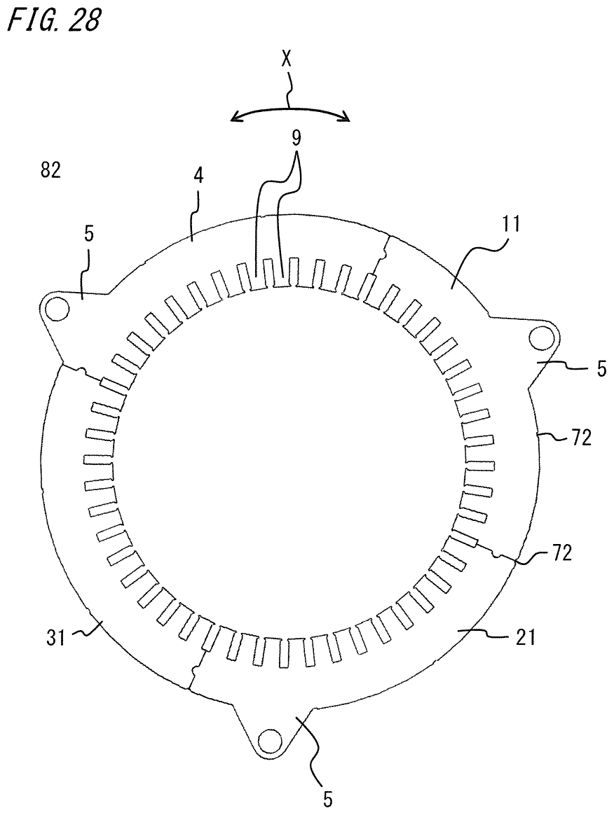

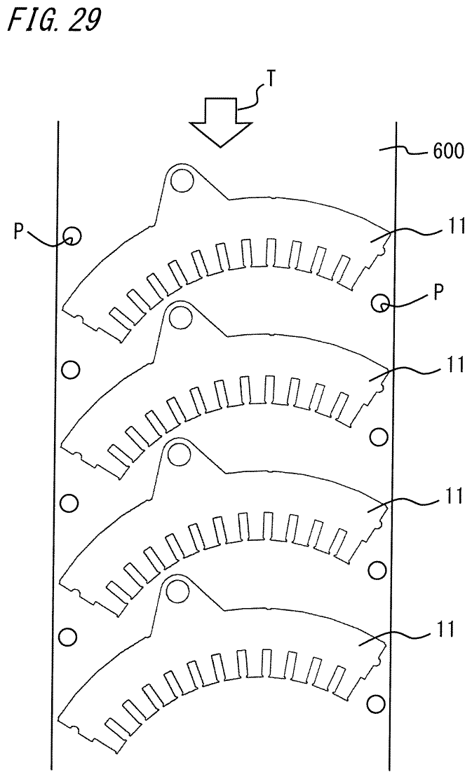

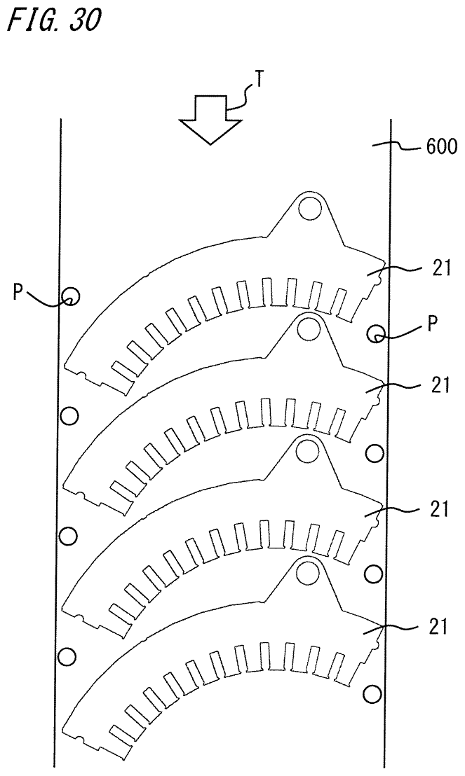

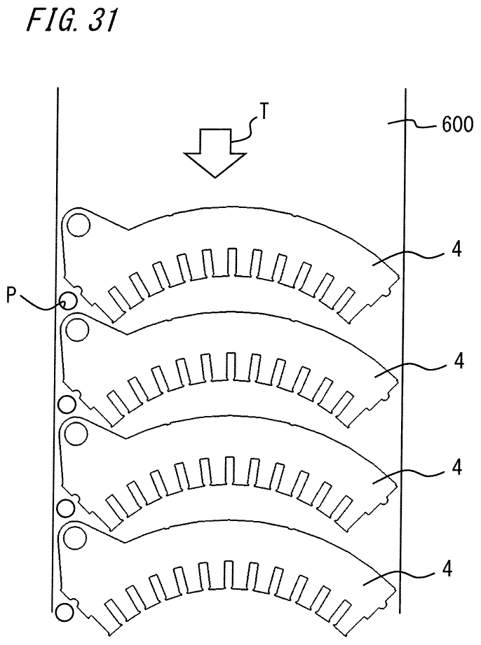

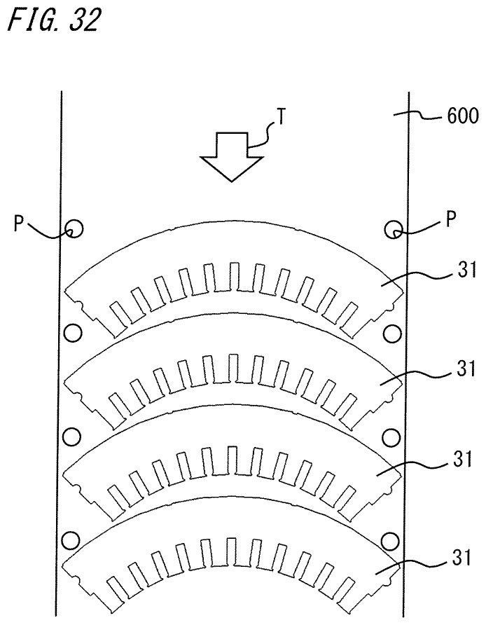

FIG. 27 is a plan view showing the configuration of a first-stage core plate of the stator core shown in FIG. 21. FIG. 28 is a plan view showing the configuration of a second-stage core plate of the stator core shown in FIG. 21. FIG. 29 is a plan view showing a manufacturing method for a first divisional core shown in FIG. 23. FIG. 30 is a plan view showing a manufacturing method for a second divisional core shown in FIG. 24. FIG. 31 is a plan view showing a manufacturing method for a third divisional core shown in FIG. 25. FIG. 32 is a plan view showing a manufacturing method for a fastening-portion-less divisional core shown in FIG. 26.

The present embodiment 3 will be described with reference to the drawings. As shown in FIG. 21 and FIG. 22, as in the above embodiments, each core plate 8 composing the stator core 80 has, at the outer circumferential surface 800, the fastening portions 5 protruding outward in the radial direction Y and having the fastening holes 51 for fastening the core plates 8 to each other in the axial direction Z. In the present embodiment 3, the core plate 8 has the fastening portions 5 of which the number M (M being an integer) is three or more, here, M=3, in the circumferential direction X. Thus, a relationship of N≥M is satisfied, and in particular, a relationship of N>M is satisfied.

As shown in FIG. 22, the division number N is four and the divisional cores 10 are equally divided. Therefore, an angle θ11 of one divisional core 10 is 90 degrees (see θ11 in FIG. 23). The fastening portions 5 are arranged at intervals of 360 degrees/M=120 degrees.

In the present embodiment 3, the divisional cores 10 include four kinds of divisional cores 10. The four kinds of divisional cores 10 are a first divisional core 11, a second divisional core 21, and a third divisional core 4 as a plurality of kinds of fastening-portion-provided divisional cores of which the fastening portions 5 are provided at a plurality of different positions separated from a center line Q1 connecting the rotation center axis Q of the rotating electrical machine 90 and the center in the circumferential direction X of each divisional core 10, and a fastening-portion-less divisional core 31 not having the fastening portion 5.

Hereinafter, each of the four kinds of divisional cores 10 will be described. As shown in FIG. 23, the first divisional core 11 has the fastening portion 5 at a position separated from the center line Q1 connecting the rotation center axis Q and the center in the circumferential direction X of the divisional core 10, here, at a position of an angle θ23 leftward on the drawing. Specifically, the angle θ23 is 5 degrees.

The outer circumferential surface 100 of the first divisional core 11 has outer-circumference recesses 72 at both ends in the circumferential direction X and at another predetermined position. The outer-circumference recesses 72 are used for positioning or for welding the core plates 8 to each other in the axial direction Z.

Next, as shown in FIG. 24, the second divisional core 21 has the fastening portion 5 at a position separated from the center line Q1 connecting the rotation center axis Q and the center in the circumferential direction X of the divisional core 10, here, at a position of an angle θ24 rightward on the drawing. Specifically, the angle θ24 is 25 degrees.

An outer circumferential surface 200 of the second divisional core 21 has outer-circumference recesses 72 at both ends in the circumferential direction X and at another predetermined position. The outer-circumference recesses 72 are used for positioning or for welding the core plates 8 to each other in the axial direction Z.

Next, as shown in FIG. 25, the third divisional core 4 has the fastening portion 5 at a position separated from the center line Q1 connecting the rotation center axis Q and the center in the circumferential direction X of the divisional core 10, here, at a position of an angle θ25 which is leftward on the drawing and different from the angle θ23 of the first divisional core 11. Specifically, the angle θ25 is 35 degrees.

An outer circumferential surface 400 of the third divisional core 4 has outer-circumference recesses 72 at both ends in the circumferential direction X and at another predetermined position. The outer-circumference recesses 72 are used for positioning or for welding the core plates 8 to each other in the axial direction Z. A projection 411 is formed at a one-side contact portion 401 which contacts with another divisional core 10 in the circumferential direction X of the third divisional core 4, and a recess 412 is formed at an other-side contact portion 402. The projection 411 and the recess 412 are used for positioning in the radial direction Y between the respective kinds of the divisional cores 10, discrimination between the front side and the back side, and the like.

Next, as shown in FIG. 26, the fastening-portion-less divisional core 31 does not have the fastening portion 5. An outer circumferential surface 300 of the fastening-portion-less divisional core 31 has outer-circumference recesses 72 at both ends in the circumferential direction X and at a predetermined position.

As shown in FIG. 27, the first-stage core plate 81 of the stator core 80 is formed by arranging the first divisional core 11, the second divisional core 21, the fastening-portion-less divisional core 31, and the third divisional core 4 in this order in the circumferential direction X. As shown in FIG. 28, the second-stage core plate 82 of the stator core 80 is formed by arranging the first divisional core 11, the second divisional core 21, the fastening-portion-less divisional core 31, and the third divisional core 4 in this order in the circumferential direction X. Here, the arrangement positions of the divisional cores 11, 21, 31, and 4 in the circumferential direction X are different between the first-stage core plate 81 and the second-stage core plate 82. In the stator core 80, the first-stage core plate 81 and the second-stage core plate 82 are sequentially stacked in the axial direction Z.

The core plates 8 formed by arranging the first divisional cores 11, the second divisional cores 21, the third divisional cores 4, and the fastening-portion-less divisional cores 31 as shown in the first-stage core plate 81 and the second-stage core plate 82, are sequentially stacked in the axial direction Z, whereby the fastening portions 5 of different kinds of divisional cores 10, i.e., the fastening portion 5 of the first divisional core 11 and the fastening portion 5 of the third divisional core 4, the fastening portion 5 of the second divisional core 21 and the fastening portion 5 of the first divisional core 11, or the fastening portion 5 of the third divisional core 4 and the fastening portion 5 of the second divisional core 21, are stacked on the upper and lower sides in the axial direction Z.

Thus, between the upper and lower sides in the axial direction Z, as shown in FIG. 22, on the upper side in the axial direction Z, contact parts L1 in the circumferential direction X between the divisional cores 10 are formed at four locations, and on the lower side in the axial direction Z, contact parts L2 are formed at four locations at lapped positions indicated by dotted lines, which are shifted in the circumferential direction X from the above contact parts L1.

Therefore, when the core plates 8 are stacked, the first-stage core plate 81 and the second-stage core plate 82 may be stacked sequentially at third and subsequent stages, and thus, in the same manner as the stacking relationship between the first-stage core plate 81 and the second-stage core plate 82 described above, the fastening portions 5 and the fastening holes 51 are located so as to overlap each other in the axial direction Z, whereby attachment parts that can be fastened to the frame 95 can be formed. In addition, since the stator core 80 is formed with the contact parts L1 and the contact parts L2 lapped (brick-stacking state) in a staggered manner in the axial direction Z, rigidity of the stator core 80 can be ensured and the material yield can be improved.

Next, regarding manufacturing methods for the first divisional core 11, the second divisional core 21, the third divisional core 4, and the fastening-portion-less divisional core 31, relationships with the material yield will be described with reference to FIG. 29 to FIG. 32. As shown in the drawings, in a thin plate 600 (plate thickness: 0.25 mm to 0.3 mm or smaller) such as an electromagnetic steel sheet for manufacturing the divisional cores 10, the divisional cores 10 and pilot holes P used for positioning in stamping are arranged so as to minimize areas that are not used for products. In general, increasing the division number can reduce the areas (ineffective areas) that are not used for products. In addition, in a case where the division number is six, one divisional core 10 can be made small, and therefore a plurality of divisional cores 10 can be arranged in a staggered manner on a steel sheet, whereby the material yield can be further improved. The feeding direction of the thin plate is indicated by an arrow T.

FIG. 29 shows die arrangement positions of the first divisional cores 11. FIG. 30 shows die arrangement positions of the second divisional cores 21. FIG. 31 shows die arrangement positions of the third divisional cores 4. In a case of manufacturing the first divisional core 11 and the second divisional core 21 in this way, the material yield is approximately 52.8%. In a case of manufacturing the third divisional core 4 in this way, the material yield is approximately 56%. FIG. 32 shows a die placement configuration for the fastening-portion-less divisional core 31. In a case of manufacturing the fastening-portion-less divisional core 31 in this way, the material yield is approximately 63.5%.

As described above, the material yield for the fastening-portion-less divisional core 31 not having the fastening portion 5 is higher than the material yields for the first divisional core 11, the second divisional core 21, and the third divisional core 4. Therefore, even in the case of including the first divisional core 11, the second divisional core 21, and the third divisional core 4 which have the fastening portions 5, the material yield for the entire stator core 80 can be improved.

In the stator core for the rotating electrical machine, the stator, and the rotating electrical machine according to embodiment 3 configured as described above, the same effects as in the above embodiments are provided, and in addition, as the fastening-portion-provided divisional cores, three or more kinds of fastening-portion-provided divisional cores are provided.

Thus, both of the material yield and freedom in designing of the fastening portion are further improved.

### Embodiment 4

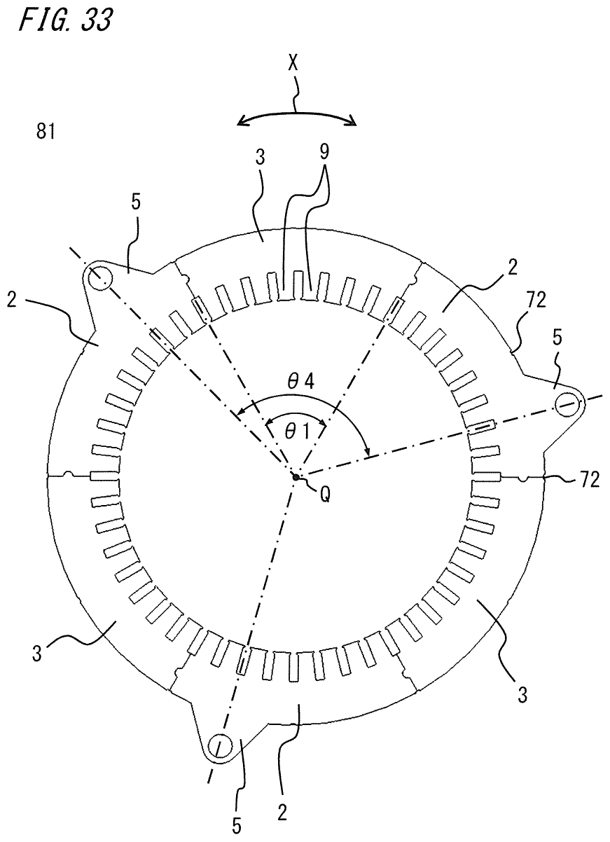

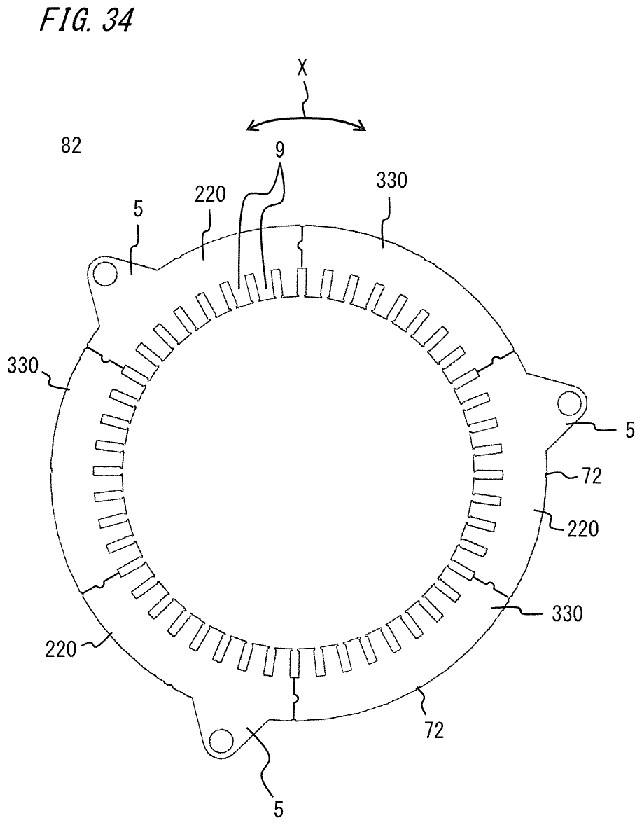

FIG. 33 is a plan view showing the configuration of a first-stage core plate of a stator core for a rotating electrical machine according to embodiment 4. FIG. 34 is a plan view showing the configuration of a second-stage core plate of the stator core for the rotating electrical machine according to embodiment 4. The same parts as those in the above embodiments are denoted by the same reference characters and the description thereof is omitted as appropriate. Here, difference from the above embodiments will be mainly described.

In the present embodiment 4, a case where the first-stage core plate 81 and the second-stage core plate 82 including the divisional cores 10 are formed with the front and back sides reversed from each other, will be described. As shown in FIG. 33, the first-stage core plate 81 is formed in the same manner as in the above embodiment 1. The second divisional cores 2 and the fastening-portion-less divisional cores 3 are arranged alternately in the circumferential direction X. As shown in FIG. 34, the second-stage core plate 82 is formed such that back second divisional cores 220 obtained by reversing the front and back sides of the second divisional cores 2, and back fastening-portion-less divisional cores 330 obtained by reversing the front and back sides of the fastening-portion-less divisional cores 3, are arranged alternately in the circumferential direction X.

The first-stage core plates 81 and the second-stage core plates 82 configured as described above are sequentially stacked in the axial direction Z, whereby the stator core 80 is formed with the contact parts L1 and the contact parts L2 arranged in a lapping manner and thus can be formed in the same manner as in the above embodiments.

Two kinds of fastening-portion-provided divisional cores, i.e., the second divisional core 2 and the back second divisional core 220, can be formed by the same die, and the fastening-portion-less divisional core 3 and the back fastening-portion-less divisional core 330 can be formed by the same die. Therefore, four kinds of divisional cores 10 can be manufactured by two kinds of dies, and thus the number of kinds of dies can be decreased, leading to cost reduction. In addition, since the divisional cores 10 are used with the front and back sides reversed from each other, plate thickness deviations of electromagnetic steel sheets can be reduced. In addition, stamping burrs produced at the time of stamping are not aligned in the stacking direction, and therefore short-circuit in the stacking direction can be suppressed and eddy current loss can be reduced.

In the stator core for the rotating electrical machine, the stator, and the rotating electrical machine according to embodiment 4 configured as described above, the same effects as in the above embodiments are provided, and in addition, the core plates are formed such that the divisional cores are arranged with front and back sides reversed from each other so as to serve as a plurality of kinds.

Thus, shear droop surfaces of the divisional cores face each other, so that a short-circuit path in the stacking direction can be interrupted and iron loss is reduced. In addition, plate thickness deviations of the core plates can be reduced.

### Embodiment 5

In the above embodiments, the example in which the relationship between the division number N and the number M of the fastening portions 5 is N>M and the fastening-portion-less divisional cores are used, has been shown. In the present embodiment, a case where the relationship between the division number N and the number M of the fastening portions 5 is N=M and the fastening-portion-less divisional cores are not used, will be described. The same parts as those in the above embodiments are denoted by the same reference characters and the description thereof is omitted as appropriate. Here, difference from the above embodiments will be mainly described.

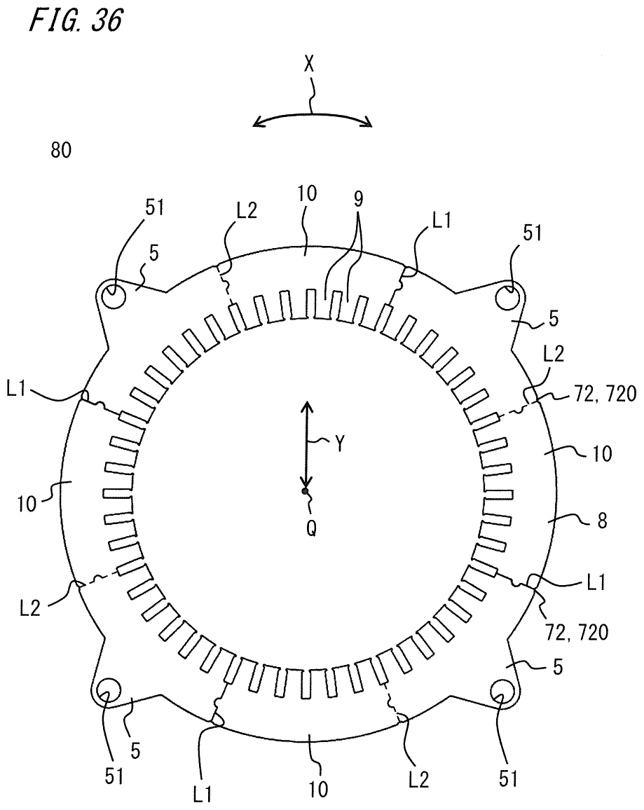

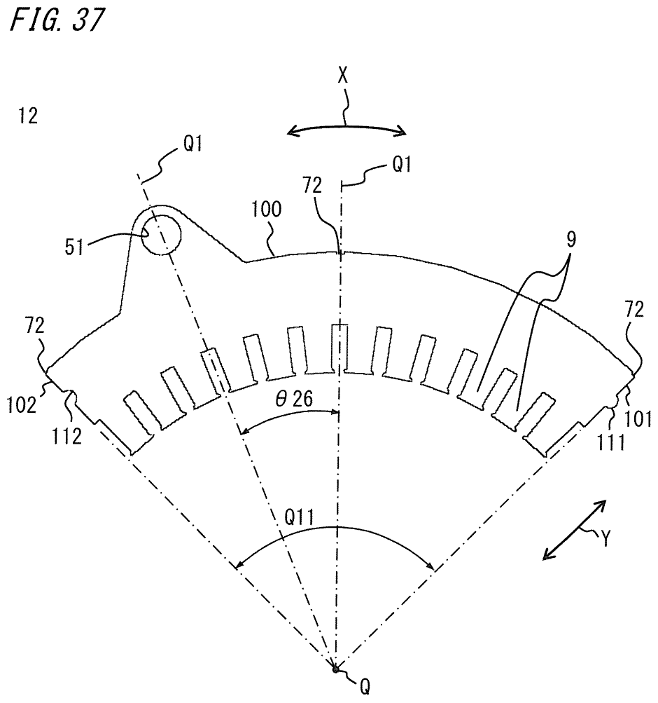

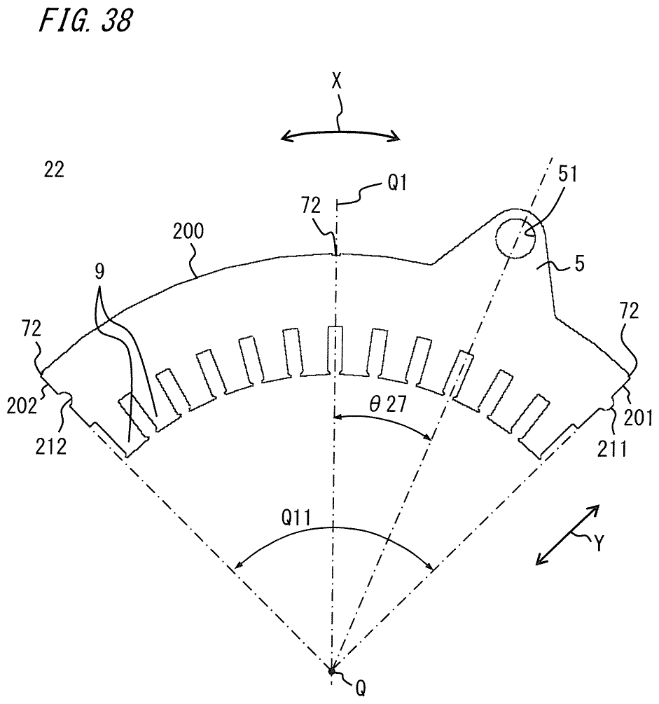

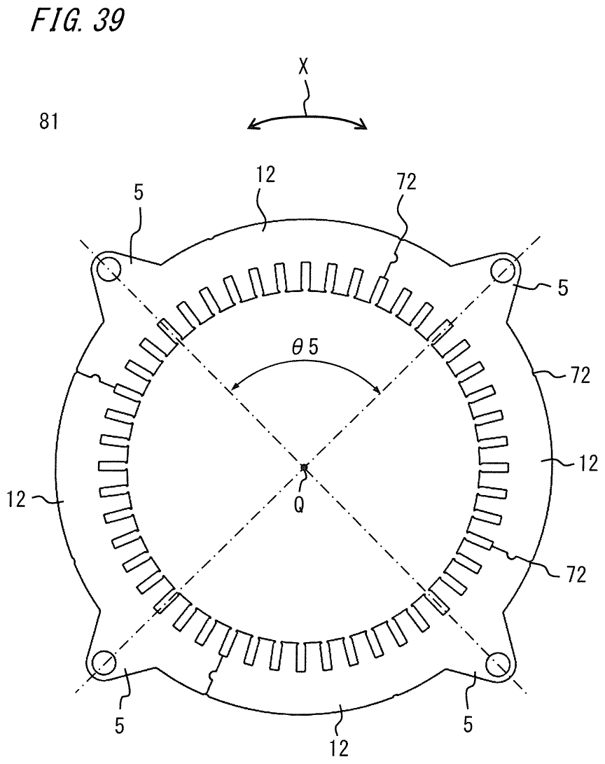

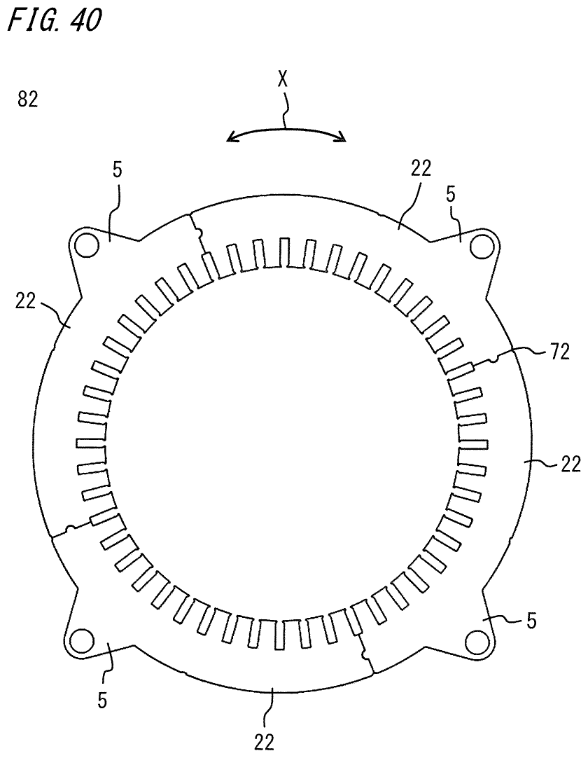

FIG. 35 is a perspective view showing the configuration of a stator core for a rotating electrical machine according to embodiment 5. FIG. 36 is a plan view showing the configuration of the stator core shown in FIG. 35. FIG. 37 is a plan view showing the configuration of a first divisional core of a core plate of the stator core shown in FIG. 35. FIG. 38 is a plan view showing the configuration of a second divisional core of the core plate of the stator core shown in FIG. 35. FIG. 39 is a plan view showing the configuration of a first-stage core plate of the stator core shown in FIG. 35. FIG. 40 is a plan view showing the configuration of a second-stage core plate of the stator core shown in FIG. 35.

The present embodiment 3 will be described with reference to the drawings. As shown in FIG. 35 and FIG. 36, as in the above embodiments, each core plate 8 composing the stator core 80 has, at the outer circumferential surface 800, the fastening portions 5 protruding outward in the radial direction Y and having the fastening holes 51 for fastening the core plates 8 to each other in the axial direction Z. In the present embodiment 5, the core plate 8 has the fastening portions 5 of which the number M (M being an integer) is three or more, here, M=4, in the circumferential direction X. The division number N of the core plate 8 is four. Thus, a relationship of N=M is satisfied.

As shown in FIG. 36, since the division number N is four and the divisional cores 10 are equally divided, the angle θ11 of one divisional core 10 is 90 degrees (see θ11 in FIG. 37). The fastening portions 5 are arranged at intervals of 360 degrees/M=90 degrees (see θ5 in FIG. 39).

In the present embodiment 5, the divisional cores 10 include two kinds of divisional cores 10. The two kinds of divisional cores 10 are a first divisional core 12 and a second divisional core 22 as a plurality of kinds of fastening-portion-provided divisional cores of which the fastening portions 5 are provided at a plurality of different positions separated from a center line Q1 connecting the rotation center axis Q of the rotating electrical machine 90 and the center in the circumferential direction X of the divisional core 10.

Hereinafter, each of the two kinds of divisional cores 10 will be described. As shown in FIG. 37, the first divisional core 12 has the fastening portion 5 at a position separated from the center line Q1 connecting the rotation center axis Q and the center in the circumferential direction X of the divisional core 10, here, at a position of an angle θ26 leftward on the drawing. Specifically, the angle θ26 is 22.5 degrees.

The outer circumferential surface 100 of the first divisional core 12 has outer-circumference recesses 72 at both ends in the circumferential direction X and at another predetermined position. The outer-circumference recesses 72 are used for positioning or for welding the core plates 8 to each other in the axial direction Z.

Next, as shown in FIG. 38, the second divisional core 22 has the fastening portion 5 at a position separated from the center line Q1 connecting the rotation center axis Q and the center in the circumferential direction X of the divisional core 10, here, at a position of an angle θ27 rightward on the drawing. Specifically, the angle θ27 is 22.5 degrees. Thus, the fastening portion 5 of the first divisional core 12 and the fastening portion 5 of the second divisional core 22 are formed at line-symmetric positions with respect to the center line Q1.

An outer circumferential surface 200 of the second divisional core 22 has outer-circumference recesses 72 at both ends in the circumferential direction X and at another predetermined position. The outer-circumference recesses 72 are used for positioning or for welding the core plates 8 to each other in the axial direction Z.

As shown in FIG. 39, the first-stage core plate 81 of the stator core 80 is formed by arranging four first divisional cores 12 in the circumferential direction X. As shown in FIG. 40, the second-stage core plate 82 of the stator core 80 is formed by arranging four second divisional cores 22 in the circumferential direction X. In the stator core 80, the first-stage core plate 81 and the second-stage core plate 82 are sequentially stacked in the axial direction Z.

The core plates 8 formed by arranging the first divisional cores 12 and the second divisional cores 22 as shown in the first-stage core plate 81 and the second-stage core plate 82, are sequentially stacked in the axial direction Z, whereby the fastening portions 5 of different kinds of divisional cores 10, i.e., the fastening portion 5 of the first divisional core 12 and the fastening portion 5 of the second divisional core 22, are stacked on the upper and lower sides in the axial direction Z.

Thus, between the upper and lower sides in the axial direction Z, as shown in FIG. 36, on the upper side in the axial direction Z, contact parts L1 in the circumferential direction X between the divisional cores 10 are formed at four locations, and on the lower side in the axial direction Z, contact parts L2 are formed at four locations at lapped positions indicated by dotted lines, which are shifted in the circumferential direction X from the above contact parts L1.

Therefore, when the core plates 8 are stacked, the first-stage core plate 81 and the second-stage core plate 82 may be stacked sequentially at third and subsequent stages, and thus, in the same manner as the stacking relationship between the first-stage core plate 81 and the second-stage core plate 82 described above, the fastening portions 5 and the fastening holes 51 are located so as to overlap each other in the axial direction Z, whereby attachment parts that can be fastened to the frame 95 can be formed. In addition, since the stator core 80 is formed with the contact parts L1 and the contact parts L2 lapped (brick-stacking state) in a staggered manner in the axial direction Z, rigidity of the stator core 80 can be ensured and the material yield can be improved.

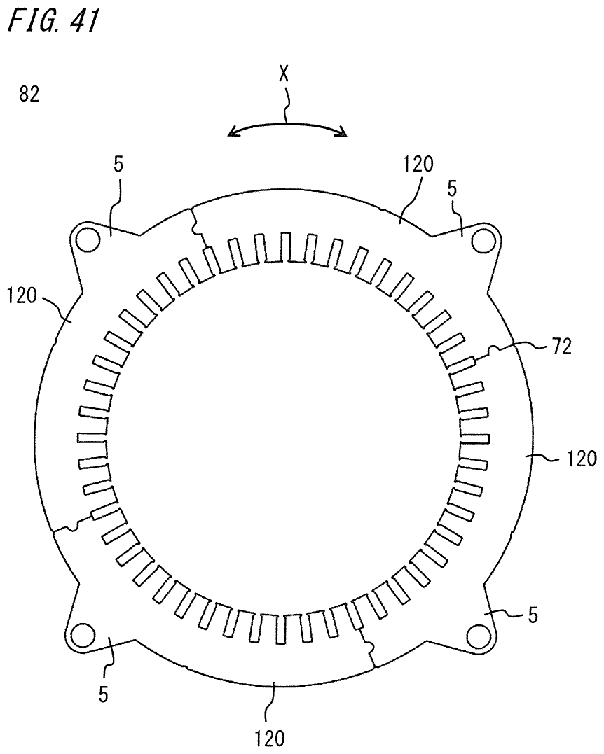

As another example in the present embodiment 5, a case where the first-stage core plate 81 and the second-stage core plate 82 including the divisional cores 10 are formed with the front and back sides reversed from each other, will be described. As shown in FIG. 39, the first-stage core plate 81 is formed by arranging four first divisional cores 12 in the circumferential direction X, as in the above case. As shown in FIG. 41, the second-stage core plate 82 is formed by arranging, in the circumferential direction X, four back first divisional cores 120 obtained by reversing the front and back sides of the first divisional core 12.

The first-stage core plates 81 and the second-stage core plates 82 configured as described above are sequentially stacked in the axial direction Z, whereby the stator core 80 is formed with the contact parts L1 and the contact parts L2 arranged in a lapping manner and thus can be formed in the Same manner as in the above embodiments.

Two kinds of fastening-portion-provided divisional cores, i.e., the first divisional core 12 and the back first divisional core 120, can be formed by the same die. Therefore, here, two kinds of divisional cores 10 can be manufactured by one kind of die, and thus the number of kinds of dies can be decreased, leading to cost reduction. In addition, since the divisional cores 10 are used with the front and back sides reversed from each other, plate thickness deviations of electromagnetic steel sheets can be reduced. In addition, stamping burrs produced at the time of stamping are not aligned in the stacking direction, and therefore short-circuit in the stacking direction can be suppressed and eddy current loss can be reduced.

In the stator core for the rotating electrical machine, the stator, and the rotating electrical machine according to embodiment 5 configured as described above, the stator core is formed by stacking a plurality of core plates in an axial direction. Each core plate has a plurality of teeth and is divided in a circumferential direction, and is formed such that divisional cores of which a division number N (N being an integer) is four or more are arranged in contact with each other in the circumferential direction. The core plate has, on an outer circumferential side thereof, fastening portions protruding outward in a radial direction and having fastening holes for fastening the core plates in a stacking direction. A number M (M being an integer) of the fastening portions in the circumferential direction is three or more, and a relationship of N≥M is satisfied. The divisional cores include a plurality of kinds of fastening-portion-provided divisional cores of which the fastening portions are provided at a plurality of different positions separated from a center line connecting a rotation center axis of the rotating electrical machine and a circumferential-direction center of each divisional core. The fastening portions of different kinds of the fastening-portion-provided divisional cores are stacked on upper and lower sides in the stacking direction. The core plates are stacked such that contact parts of the divisional cores are located at positions different in the circumferential direction on the upper and lower sides in the stacking direction. The fastening holes of the fastening portions are formed in communication with each other in the stacking direction.

Thus, even in a case where the division number N is equal to the number M of the fastening portions, both of material yield improvement and freedom in designing of the fastening portion can be achieved, as in the above embodiments.

In the above embodiments, the example in which the divisional cores 10 are equally divided in the circumferential direction X, has been shown. However, without limitation thereto, for example, the first divisional core and the second divisional core may be formed with the same angle in the circumferential direction, and the fastening-portion-less divisional core may be formed with an angle greater than the angles of the first divisional core and the second divisional core in the circumferential direction, or may be formed with an angle that is half the angles of the first divisional core and the second divisional core in the circumferential direction. In this case, the proportion of the fastening-portion-less divisional core in the core plate increases, so that the material yield for the entire core plate is improved or the material yield for the fastening-portion-less divisional core is improved.

Although the disclosure is described above in terms of various exemplary embodiments and implementations, it should be understood that the various features, aspects, and functionality described in one or more of the individual embodiments are not limited in their applicability to the particular embodiment with which they are described, but instead can be applied, alone or in various combinations to one or more of the embodiments of the disclosure.

It is therefore understood that numerous modifications which have not been exemplified can be devised without departing from the scope of the present disclosure. For example, at least one of the constituent components may be modified, added, or eliminated. At least one of the constituent components mentioned in at least one of the preferred embodiments may be selected and combined with the constituent components mentioned in another preferred embodiment.

### DESCRIPTION OF THE REFERENCE CHARACTERS

1 first divisional core
10 divisional core
100 outer circumferential surface
101 one-side contact portion
102 other-side contact portion
111 projection
112 recess
11 first divisional core
12 first divisional core
120 back first divisional core
2 second divisional core
200 outer circumferential surface
201 one-side contact portion
202 other-side contact portion
21 second divisional core
22 second divisional core
211 projection
212 recess
220 back second divisional core
3 fastening-portion-less divisional core
300 outer circumferential surface
301 one-side contact portion
302 other-side contact portion
330 back fastening-portion-less divisional core
311 projection
312 recess
4 third divisional core
400 outer circumferential surface
401 one-side contact portion
402 other-side contact portion
411 projection
412 recess
5 fastening portion
51 fastening hole
72 outer-circumference recess
720 groove
8 core plate
800 outer circumferential surface
9 tooth
90 rotating electrical machine
91 stator
92 rotor
93 coil
931 terminal portion
95 frame
H1 feed pitch
H2 feed pitch
H3 feed pitch
L1 contact part
L2 contact part
P pilot hole
Q rotation center axis
Q1 center line
W1 material width
W2 material width
W3 material width
X circumferential direction
Y radial direction
Z axial direction
θ1 angle
θ11 angle
θ21 angle
θ22 angle
θ23 angle
θ24 angle
θ25 angle
θ26 angle
θ27 angle
θ3 angle
θ4 angle
θ5 angle

1. A stator core for a rotating electrical machine, wherein
the stator core is formed by stacking a plurality of core plates in an axial direction,
each core plate has a plurality of teeth formed at equal intervals in a circumferential direction and is divided in the circumferential direction, and is formed such that divisional cores of which a division number N, N being an integer, is four or more are arranged in contact with each other in the circumferential direction,
each core plate has, on an outer circumferential side thereof, fastening portions protruding outward in a radial direction and having fastening holes for fastening the core plates in a stacking direction,
a number M, M being an integer, of the fastening portions in the circumferential direction is three or more, and a relationship of N≥M is satisfied,
the divisional cores include a plurality of kinds of fastening-portion-provided divisional cores of which the fastening portions are provided at a plurality of different positions separated from a center line connecting a rotation center axis of the rotating electrical machine and a circumferential-direction center of each divisional core,
the plurality of kinds of fastening-portion-provided divisional cores each have a plurality of the teeth,
the fastening portions of different kinds of the fastening-portion-provided divisional cores are stacked on upper and lower sides in the stacking direction,
the core plates are stacked such that contact parts of the divisional cores are located at positions different in the circumferential direction on the upper and lower sides in the stacking direction,
slots are formed between the teeth of the core plates so as to be in communication with each other in the axial direction, and
the fastening holes of the fastening portions are formed in communication with each other in the stacking direction.

2. The stator core for the rotating electrical machine, according to claim 1, wherein
a relationship of N>M is satisfied, and
the divisional cores include a fastening-portion-less divisional core not having the fastening portion.

3. The stator core for the rotating electrical machine, according to claim 1, wherein
as the fastening-portion-provided divisional cores, at least two kinds of fastening-portion-provided divisional cores are provided, one of the two kinds being defined as a first divisional core and another one being defined as a second divisional core, and
the fastening portion of the first divisional core and the fastening portion of the second divisional core are formed at line-symmetric positions with respect to the center line.

4. The stator core for the rotating electrical machine, according to claim 1, wherein
as the fastening-portion-provided divisional cores, three or more kinds of fastening-portion-provided divisional cores are provided.

5. The stator core for the rotating electrical machine, according to claim 1, wherein
the division number N of the core plate is set at N=6,
the number M of the fastening portions is set at M=3 or M=4, and
the fastening portions are arranged at intervals of 360 degrees/M in the circumferential direction.

6. The stator core for the rotating electrical machine, according to claim 1, wherein
the divisional cores are fixed by being bonded to each other, in the stacking direction.

7. The stator core for the rotating electrical machine, according to claim 1, wherein
the core plates have, on outer circumferential surfaces thereof, outer-circumference recesses formed at such positions that the outer-circumference recesses extend contiguously in the stacking direction.

8. The stator core for the rotating electrical machine, according to claim 7, wherein
a welding portion for fixing the divisional cores in the stacking direction is provided at a groove formed by the outer-circumference recesses extending contiguously in the stacking direction.

9. The stator core for the rotating electrical machine, according to claim 1, wherein
the core plates are formed such that the divisional cores are arranged with front and back sides reversed from each other so as to serve as a plurality of kinds.

10. The stator core for the rotating electrical machine, according to claim 1, wherein
the divisional cores of each core plate are formed so as to be equally divided in the circumferential direction.

11. A stator comprising:
the stator core for the rotating electrical machine according to claim 1; and
a coil wound around the teeth of the stator core with an insulator therebetween.

12. A rotating electrical machine comprising:
the stator according to claim 11; and
a rotor rotatably provided so as to be opposed to the stator with a gap therebetween.

13. A stator core for a rotating electrical machine, wherein
the stator core is formed by stacking a plurality of core plates in an axial direction,
each core plate has a plurality of teeth and is divided in a circumferential direction, and is formed such that divisional cores of which a division number N, N being an integer, is four or more are arranged in contact with each other in the circumferential direction,
each core plate has, on an outer circumferential side thereof, fastening portions protruding outward in a radial direction and having fastening holes for fastening the core plates in a stacking direction,
a number M, M being an integer, of the fastening portions in the circumferential direction is three or more, and a relationship of N≥M is satisfied,
the divisional cores include a plurality of kinds of fastening-portion-provided divisional cores of which the fastening portions are provided at a plurality of different positions separated from a center line connecting a rotation center axis of the rotating electrical machine and a circumferential-direction center of each divisional core,
the fastening portions of different kinds of the fastening-portion-provided divisional cores are stacked on upper and lower sides in the stacking direction,
the core plates are stacked such that contact parts of the divisional cores are located at positions different in the circumferential direction on the upper and lower sides in the stacking direction,
the fastening holes of the fastening portions are formed in communication with each other in the stacking direction, and
as the fastening-portion-provided divisional cores, three or more kinds of fastening-portion-provided divisional cores are provided.

14. The stator core for the rotating electrical machine, according to claim 2, wherein
as the fastening-portion-provided divisional cores, at least two kinds of fastening-portion-provided divisional cores are provided, one of the two kinds being defined as a first divisional core and another one being defined as a second divisional core, and
the fastening portion of the first divisional core and the fastening portion of the second divisional core are formed at line-symmetric positions with respect to the center line.

15. The stator core for the rotating electrical machine, according to claim 2, wherein
as the fastening-portion-provided divisional cores, three or more kinds of fastening-portion-provided divisional cores are provided.

16. The stator core for the rotating electrical machine, according to claim 3, wherein
as the fastening-portion-provided divisional cores, three or more kinds of fastening-portion-provided divisional cores are provided.

17. The stator core for the rotating electrical machine, according to claim 2, wherein
the division number N of the core plate is set at N=6,
the number M of the fastening portions is set at M=3 or M=4, and
the fastening portions are arranged at intervals of 360 degrees/M in the circumferential direction.

18. The stator core for the rotating electrical machine, according to claim 3, wherein
the division number N of the core plate is set at N=6,
the number M of the fastening portions is set at M=3 or M=4, and
the fastening portions are arranged at intervals of 360 degrees/M in the circumferential direction.

19. The stator core for the rotating electrical machine, according to claim 4, wherein
the division number N of the core plate is set at N=6,
the number M of the fastening portions is set at M=3 or M=4, and
the fastening portions are arranged at intervals of 360 degrees/M in the circumferential direction.

20. The stator core for the rotating electrical machine, according to claim 2, wherein
the divisional cores are fixed by being bonded to each other, in the stacking direction.
